(19) United States
(12) Patent Application Publication
(10) Pub. No.: US 2010/0058343 A1
(43) Pub. Date: Mar. 4, 2010

(54) WORKFLOW TRACKING SYSTEM, INTEGRATION MANAGEMENT APPARATUS, METHOD AND INFORMATION RECORDING MEDIUM HAVING RECORDED IT

(76) Inventor: Shinji Kikuchi, Tokyo (JP)

Correspondence Address: Mr. Jackson Chen, 6535 N. STATE HWY 161, IRVING, TX, 75039, US

(21) Appl. No.: 12/513,998

(22) PCT Filed: Nov. 6, 2007
(86) PCT No.: PCT/JP2007/071541

§ 371 Date: May 7, 2009

(30) Foreign Application Priority Data
Nov. 7, 2006 (JP) 2006-301808

(51) Int. Cl. G06F 9/46

(52) U.S. Cl. 718/100

(57) ABSTRACT

To provide a workflow tracking apparatus having scalability that can be efficiently operated. A framework of management using a hierarchical structure such as DNS is introduced. A simple decentralization structure leads to a failure in establishing semantic consistencies of Wf definition and meta-information, results in incapability of management. Therefore, there are additionally prepared (1) an element measure that manages, as a predetermined designated standard form, the descriptions of element workflows to be decentralized; (2) an element measure that transforms the descriptions of element workflows to be decentralized into the standard form; and (3) a workflow combining measure that combines the descriptions of element workflows to be decentralized, thereby reproducing the description of the entire workflows. These measures are used to combine the descriptions of element workflows to be decentralized, thereby generating consistent Wf definition and meta-information, thereafter copying replicas of them to a workflow monitor system that manages the domain.

### TECHNICAL FIELD

The present invention relates to progress tracking and state evaluations of works performed on a work application system by using a workflow management system in which a plurality of work application system groups are associated to achieve associated works, usually with or without of the use of the Internet.

### BACKGROUND ART

FIG. 9 and FIG. 10 show two cases of methods regarding a related work process tracking apparatus. Both are the methods that employs a decentralized management concept in the work process tracking apparatuses. The method of FIG. 9 has an issue regarding scalability, while the method of FIG. 10 has an issue regarding efficiency and the like.

FIG. 9 is an illustration of a system structure example of the method which uses a technique related to work process tracking based on a decentralized workflow management method having a decentralized management concept, which is depicted in Japanese Unexamined Patent Publication 2007-257513.

The work process tracking apparatus based on the decentralized workflow management method is configured, including: a plurality of workflow systems 101 (marked as WfMS_1), 102 (marked as WfMS_2) based on the decentralized workflow management method; a plurality of self-loaded existing workflow systems 103; a proxy system 104 (marked as PrxS) which consolidates the plurality of existing workflow systems 103 and acts as an proxy for the decentralized workflow management method; a decentralized workflow monitor system 105 (marked as DsWfMS) which collects various kinds of event information from the workflow systems 101, 102, and the proxy system 104, and then arranges, integrates, and stores those information; and client sites 106 and 160 of a Web browser, as client systems for making an access to the decentralized workflow monitor system 105.

Further, in FIG. 9, the workflow system 101 communicates with a plurality of work application systems 107 (marked as AP_A) and 108 (marked as AP_B). Further, the workflow system 102 communicates with a plurality of work application systems 109 (marked as AP_C) and 110 (marked as AP_D). Furthermore, the workflow system 103 communicates with a plurality of work application systems 111 (marked as AP_E) and 112 (marked as AP_F) via the proxy system 104.

In order to achieve the above, the work application system 107 includes a data communication part 113 (marked as COM_A). Further, the work application system 108 includes a data communication part 114 (marked as COM_B).

Similarly, the work application system 109 includes a data communication part 115 (marked as COM_C). Further, the work application system 110 includes a data communication part 116 (marked as COM_D).

Similarly, the work application system 111 includes a data communication part 117 (marked as COM_E). Further, the work application system 112 includes a data communication part 118 (marked as COM_F).

In the meantime, the workflow system 101 includes an adapter 119 (marked as AD1_A) for performing communication with the data communication part 113 and another adapter 120 (marked as AD1_B) for performing communication with the data communication part 113. These adapters convert disparities on communication protocols and operational disparities when the work application system 107 and the work application system 108 perform necessary communication, as a result of a control in the operation orders performed by a workflow engine 129 (marked as WfE_1) included in the workflow system 101.

Similarly, the workflow system 102 includes an adapter 121 (marked as AD2_C) for performing communication with the data communication part 115 and another adapter 122 (marked as AD2_D) for performing communication with the data communication part 116. These adapters convert disparities on communication protocols and operational disparities when the work application system 109 and the work application system 110 perform necessary communication, as a result of a control in the operation orders performed by a workflow engine 132 (marked as WfE_2) included in the workflow system 102.

Similarly, the workflow system 103 includes an adapter 123 (marked as AD3_E) for performing communication with the data communication part 117 and another adapter 124 (marked as AD3_F) for performing communication with the data communication part 118. These adapters convert disparities on communication protocols and operational disparities when the work application system 111 and the work application system 112 perform necessary communication, as a result of a control in the operation orders performed by a workflow engine 137 (marked as WfE_3) included in the workflow system 103.

It is assumed that the workflow system 103 is an individually-mounted existing workflow engine, so that communication between the data communication part 117 and the adapter 123 as well as communication between the data communication part 118 and the adapter 124 are achieved via a proxy part 135 (marked as Prx_3) within the proxy system 104.

The behavior of the workflow engine 129 is defined in a workflow definition 131 (marked as Wf definition_1) included in the workflow system 101. The definition regulates what state the workflow engine 129 comes to go under, and what kinds of processing request and processing response message the workflow engine 129 issues, when there are events generated related to a processing request and a processing response message from the workflow system 103 communicated via the other dispersedly placed workflow system 102 and the proxy system 104 and also events occurred related to a processing request and a processing response message generated as a result of communication performed between a plurality of work application systems 107 and 108. Normally, the workflow definition 131 describes only the behavior of the workflow engine 129 in process descriptions such as standardized forms of WS-BPEL (Web Service Business Process Execution Language) and WSDL (Web Service Definition Language).

The behavior of the workflow engine 132 is defined in a workflow definition 134 (marked as Wf definition_2) included in the workflow system 102. The definition regulates what state the workflow engine 132 comes to go under, and what kinds of processing request and processing response message the workflow engine 132 issues, when there are events generated related to a processing request and a processing response message from the workflow system 103 communicated via the other dispersedly placed workflow system 101 and the proxy system 104 and also events occurred related to a processing request and a processing response message generated as a result of communication performed between a plurality of work application systems 109 and 110. Normally, the workflow definition 134 describes only the behavior of the workflow engine 132 process descriptions such as standardized forms of WS-BPEL and WSDL.

The behavior of the workflow engine 137 is defined in a workflow definition 139 (marked as Wf definition_3) included in the workflow system 103. The definition regulates what state the workflow engine 137 comes to go under, and what kinds of processing request and processing response message the workflow engine 137 issues, when there are events generated related to a processing request and a processing response message from the other workflow systems 101 and 102 via the proxy system 104 and also events generated related to a processing request and a processing response message from a plurality of workflow application systems 111 and 112 via the proxy system 104. The workflow system 103 is assumed to be the individually-mounted existing workflow engine so that the workflow definition 139 is not necessarily written in the standardized forms of WS-BPEL and WSDL. In that case, a Wf definition/service definition acquiring part 155 to be described later converts the definition into a standardized form that is similar to WS-BPEL and WSDL.

The events related to the processing request and processing response message generated in the workflow system 101 are detected by a plurality of event extracting parts provided dispersedly within the workflow system 101. Communications between the data communication part 113 and the adapter 119 are all detected by an Msg event extracting part 125 provided inside the adapter 119. Similarly, communications between the data communication part 114 and the adapter 120 are all detected by an Msg event extracting part 126 provided inside the adapter 120. The behavior of the workflow engine 129 is detected by an Eng event extracting part 130.

Event information extracted by the Msg event extracting part 125, the Msg event extracting part 126, and the Eng event extracting part 130 is temporarily stored in an event data keeping part 140 within the workflow system 101, and it is transferred to the decentralized workflow monitor system 105 by a common data transmitting part 141 as appropriate.

The events related to the processing request and processing response message generated in the workflow system 102 are detected by a plurality of event extracting parts provided dispersedly within the workflow system 102. Communications between the data communication part 115 and the adapter 121 are all detected by an Msg event extracting part 127 provided inside the adapter 121. Similarly, communications between the data communication part 116 and the adapter 122 are all detected by an Msg event extracting part 128 provided inside the adapter 122. The behavior of the workflow engine 132 is detected by an Eng event extracting part 133.

Event information extracted by the Msg event extracting part 127, the Msg event extracting part 128, and the Eng event extracting part 133 is temporarily stored in an event data keeping part 142 within the workflow system 102, and it is transferred to the decentralized workflow monitor system 105 by a common data transmitting part 143 as appropriate.

The processing method for collecting the event group related to the processing request and the processing response message generated in the workflow system 103 is different, since it is the self-loaded existing workflow engine. Communications between the data communication part 117 and the adapter 123 are performed via the proxy part 135. Therefore, the events regarding the generated processing request and the processing response message are detected by a Prx event extracting part 136 that is connected to the proxy part 135 within the proxy system 104. The events regarding the processing request and the processing response message generated in the communications between the data communicating part 118 and the adapter 124 are also detected by the Prx event extracting part 136.

The event information extracted by the Prx event extracting part 136 is temporarily kept in the event data keeping part 145 within the proxy system 104.

In the meantime, the behavior of the workflow engine 137 is detected by an Eng event extracting part 138 that is provided within the workflow system 103. Thereafter, data related to the events is transmitted to the proxy system 104 as appropriate by using the common data transmitting part 147 that is provided within the workflow system 103.

Thereafter, the proxy system 104 collects data related to the events by using the own common data receiving part 146, and keeps it temporarily in the event data keeping part 145 within the proxy system 104.

All the data related to the evens temporarily kept in the event data keeping part 145 are transferred as appropriate to the decentralized workflow monitor system 105 by the common data transmitting part 144.

The decentralized workflow monitor system 105 includes: the Wf definition/service definition acquiring part 155 which receives the workflow definition 131, the workflow definition 134, and the workflow definition 139 (marked as Wf definition_3), and applies conversion partially; a Wf combining part 148 which combines a unified workflow definition from all the workflow definitions acquired by the Wf definition/service definition acquiring part 155; and a combined Wf definition 150 which stores and manages the combined workflow definition.

Especially, the Wf definition/service definition acquiring part 155 is capable of making an access to a repository 156 placed outside.

Furthermore, the decentralized workflow monitor system 105 also includes: an event data receiving part 149 which receives all the data related to the events from the workflow system 101, the workflow system 102, and the proxy system 104; an event storage DB 152 which arranges all the event data received at the event data receiving part 149, and keeps the data in a related manner by referring to the combined Wf definition 150; and an event data associating part 151 which performs actual processing for associating the data.

Moreover, the decentralized workflow monitor system 105 also includes: an AP label entering 158 which is an application for defining and naming work-related labels for the data within the combined Wf definition 150; a searching function part 153 which is an application for searching event data that corresponds to a given condition, based on the combined Wf definition 150; a tracking display creating part 154 which displays the event data in a time series manner by relating the data within the combined Wf definition 150 to the result returned from the searching function part 153; and a batching part 159 which performs statistical processing and evaluation processing based on the data stored and managed in the event storage DB 152.

In order to operate the AP label entering part 158, it is necessary to start up a screen as a Web browser for defining specific meanings to the various kinds of events. For that, it is necessary to start up at least one client site 160.

Further, it is also necessary to start up the screen as the Web browser in order to operate the searching function part 153 and the tracking display creating part 154. For that, it is necessary to start at least one client site 160.

FIG. 10 is an illustration of a system structure example of the method which uses a technique related to work process tracking based on a decentralized workflow management method having a decentralized management concept, which is depicted in Patent Document 1.

FIG. 10 shows an overall view of two organizations 201 (marked as ORG1) and 202 (marked as ORG2) involved in execution of a common work process. These two organizations are partner organizations of a same corporation or a same company, and each organization operates each part of the common work process. Alternatively, there is also a case where one of the organizations, e.g., the organization 201, is a client organization, and the client organization outsources all of or a part of the work process to the organization 202 as a supplier. The structure can be also applied to a case where there are three or more organizations which are involved in execution of the related common work process.

Each of the organizations 201 and 202 involved in the execution of the work process (hereinafter, simply referred to as involved organizations) has respective workflow management systems 203 (marked as WfMS1) and 204 (marked as WfMS2) for managing each part of the work process. Specifically, the workflow management systems 203 and 204 in each of the involved organizations 201 and 202 correspond respectively to computer-based management systems which operate on respective data processing systems. The data processing system of each of the organizations 201 and 202 includes a single, or more typically, several personal computers or workstations. When there are several personal computers or workstations, each of those is connected mutually via a data communication network such as LAN (Local Area Network) or WAN (Wide Area Network). When the organizations are dispersed in geographically different places, those are connected mutually via the Internet.

The workflow systems 203 and 204 of each of the involved organizations 201 and 202 include workflow management system servers 205 (marked as WfMS1_S) and 206 (marked as WfMS2_S), and those servers are simply referred to as workflow servers hereinafter. The workflow servers 205 and 206 are server computer applications which work and operate as the servers of the workflow management systems 203 and 204. The workflow servers 205 and 206 maintain and manage the information regarding the execution state of each part of the work process, and update it. There is a change generated in the state through an event operation on the workflow, and the information regarding the execution state is updated.

Through employing the workflow management systems 203 and 204, the typical work process can be computerized, and modeling and computerized work process are defined in syntactical units. After creating the model of the computerized work process, a template of a same class process conducted in the corporation or the company is to be formed. The process template can normally be instantiated and interpreted by the data processing system, and it is possible to judge each sequence of the work steps required for performing the work process. The sequence of the work steps depends on the instantiated context of the process template. The instance of the process template and the interpretation thereof shows each process. A basic element of the process template is called an activity. The activity indicates a work action that can also be considered as a semantical entity. The workflow activity, the execution order, and the allotted resource are written in the process template.

As shown in FIG. 10, the workflow servers 205 and 206 keep and manage a plurality of process templates 211 (marked as PT1) and 213 (marked as PT2).

The state of a process instance 209 (marked as PI1 (PT1)) of the process template 211 working on the workflow server 205 is schematically illustrated, and a corresponding process instance PI1′ (PT1) of the same process template 211 operates on the workflow server 206.

In each of the involved organizations 201 and 202, the workflow servers 205 and 206 communicate with respective state shadowing engines 215 (marked as SSE1) and 216 (marked as SSE2) which are operated on the same server computer or the work station where the respective workflow servers are operated.

Further, in each of the involved organizations 201 and 202, a plurality of workflow management system clients 217 (marked as WfMS1_C) and 218 (marked as WfMS2_C) (hereinafter, simply referred to as workflow clients) communicate with the workflow servers 205 and 206 via interfaces provided to the respective state shadowing engines 215 and 216. The workflow clients 217 and 218 are the client applications which operate on the personal computer or the workstation. Users 227 (marked as Ua), 229 (marked as Ub), 228 (marked as Uc), and 230 (marked as Ud) of the workflow management systems 203 and 204 within the organizations 201 and 202 can communicate with workflow management systems 203 and 204 to which each user belongs, by using the workflow clients 217 and 218.

Each of the workflow servers 205 and 206 has an interface. Through the interfaces, the users 227, 229, 228, and 230 within the organizations 201 and 202 can operate the workflow clients 217 and 218 to log-on to the respective workflow servers 205 and 206, refer to the state of the activities executed in the organization (start, end, completion, for example), and update the state of the activities as necessary. The different users have respective user identifiers (e.g., UIDa for the user 227, UIDb for the user 229, UIDc for the user 228, and UIDd for the user 230), and so that the workflow clients 217 and 218 can refer to the state of the workflow management system and update the state by communicating with the workflow servers 205 and 206. Different privilege levels can be allotted to the different user identifiers, and the users can operate the workflow management systems 203 and 204 with different privilege levels. For example, it is possible to allot a privilege of making a reference and updating the state of the workflow management system 203 to the user 227 that has the user identifier of UIDa, and to allot a lower privilege to the user 229 with the identifier of UIDb with which the user can only make a reference to the state of the workflow management system 203.

The state shadowing engines 215 and 216 of the two organizations 201 and 202 can communicate with each other. This communication can be achieved through connecting an arbitrary data communication infrastructure DCI which is preferable for the data processing systems of the two organizations 201 and 202, such as LAN, WAN, or the Internet.

Each of the state shadowing engines 215 and 216 achieve state shadowing functions, which makes it possible for the user of one of the organization involved in the execution of the common work process to conduct tracking of the progress of the workflow within the other involved organization. For example, through the state shadowing function, the users 227 and 229 of the workflow management system 203 within the organization 201 can conduct tracking of the progress of the workflow within the organization 202, and vice versa.

Specifically, the state shadowing functions achieved by the state shadowing engines 215 and 216 make it possible to form, in the workflow management systems 203 and 204 of the respective involved organizations 201 and 202, a shadow that is an internal copy of the part that is executed by the other organization among the common work process.

When an operation is conducted by one of the involved organization (the organization 202, for example) during the execution of each part of the common work process, the local workflow management system 204 changes the state, and sends a message for notifying the state change to the workflow management system of the other organization (the organization 201, for example) via the respective state shadowing engine 216. The state shadowing engine of the involved organization 201 receives the message, and converts it as necessary to generate a corresponding state change as necessary. Thereby, the state of the workflow management system 204 of the organization 202 can be duplicated.

The state shadowing engines 215 and 216 can communicate with each other between the servers thereof by using the existing interfaces 207 (marked as WfMS1_SI) and 208 (marked as WfMS2_SI) of the respective workflow servers 205 and 206.

Therefore, respective user identifiers UIDx and UIDy having appropriate high-level privileges are defined in the state shadowing engines 215 and 216. The state shadowing engines 215 and 216 use the user identifiers UIDx and UIDy, when making log-on to the respective workflow servers 205 and 206. From the above, the state shadowing engines 215 and 216 are considered as a single workflow client from the workflow servers 205 and 206 which are the respective communication partners.

Patent Document 1: Japanese Unexamined Patent Publication 2004-5550

Patent Document 2: Japanese Unexamined Patent Publication 2007-257513

Issues regarding the related work process tracking apparatus will be described. The method using the technique related to the work process tracking based on the decentralized workflow management method of a decentralized management concept illustrated in FIG. 9 overcomes the issues for the used-to-be mainstream centralized management method related to the workflow management. However, the event data receiving part 149 within the decentralized workflow monitor system 105 illustrated in FIG. 9 is structured to receive all the data related to events. Thus, in a large-scale operating environment where the number of workflow systems (WfMS_1, WfMS_2) within FIG. 9 is increased, the decentralized workflow monitor system 105 itself becomes a bottleneck, which at this point causes such an issue in terms of the scalability. This is caused due to the fact that the Wf definition and meta-information are integrated/combined in order to achieve the work process tracking based on the decentralized workflow management method. This is called herein as “issues regarding scalability limit caused due to achieving semantical integration in the method with decentralized management concept used in work process tracking processing”.

It is also possible with the work process tracking apparatus shown in FIG. 10 to manage the progress of the decentralized workflow. With this method, theoretically, all of the plurality of workflow servers share the progress management of the decentralized workflows. Thus, through checking the workflow client for an arbitrary workflow server, tracking of the work can be achieved. With this method, however, tracking of the work cannot be achieved without communicating the progress mutually within all of the plurality of workflow servers. In this case, when there are N-number of participating workflow servers, theoretically a square of N communications are to be generated for a single communication. Thus, it is concerned that the network use efficiency may be deteriorated. This is called herein as “issues regarding management inefficiency of method with decentralized management concept used in work process tracking processing”.

It is an object of the present invention to provide a workflow tracking system, an integration management apparatus, method, program, and an information recording medium having the program recorded therein, which can overcome “issues regarding scalability limit caused due to achieving semantical integration in method with decentralized management concept used in work process tracking processing” described in FIG. 9 without generating “issues regarding management inefficiency of method with decentralized management concept used in work process tracking processing” described in FIG. 10.

### DISCLOSURE OF THE INVENTION

In order to achieve the foregoing object, a first aspect of the present invention provides a workflow tracking system having a plurality of workflow execution apparatuses for managing/executing a workflow and a plurality of workflow integration management apparatuses for tracking the workflow. Each of the workflow execution apparatuses includes: a device which shows contents of events generated in the apparatus itself when executing an arbitrary workflow managed by the apparatus itself, and records peculiar event information by each of the events; a device which transmits a workflow description which shows contents of the workflow in a standardized data form to a single master workflow integration management apparatus that is determined in advance among the workflow integration management apparatuses; and a device which transmits the recorded event information to a subordinate workflow integration management apparatus that is determined in advance for each of the workflow execution apparatuses. The workflow integration management apparatus includes: an event association detecting device which detects association of each event specified by the event information acquired from each of the workflow execution apparatuses with respect to other events; and an event information recording device which records all of the event information acquired from each of the workflow execution apparatuses. The master workflow integration management apparatus includes, in addition to the event association detecting device and the event information recording device: a device which integrates a plurality of the workflows to generate an integrated workflow based on the workflow descriptions and the event information acquired from each of the workflow execution apparatuses and based on a detection result of the event association detecting device; and a device which transmits a replica of the integrated workflow to the subordinate workflow integration management apparatuses other than the master workflow integration management apparatus. The subordinate workflow integration management apparatus includes, in addition to the event association detecting device and the event information recording device, a device which receives the replica of the integration workflow from the master workflow integration management apparatus.

In order to achieve the foregoing object, a second aspect of the present invention provides a workflow tracking system having a plurality of workflow execution apparatuses for managing/executing a workflow and a plurality of workflow integration management apparatuses for tracking the workflow. The workflow tracking system is formed in a hierarchical structure configured with a single master domain formed with the single master workflow integration management apparatus and at least a single workflow execution apparatus, and at least a single subordinate domain belonging to the master domain, which is formed with the single subordinate workflow integration management apparatus and at least a single workflow execution apparatus. Each of the workflow execution apparatuses includes: a device which shows contents of events generated in the apparatus itself when executing an arbitrary workflow managed by the apparatus itself, and records peculiar event information by each of the events; a device which transmits a workflow description which shows contents of the workflow in a standardized data form to the master workflow integration management apparatus; and a device which transmits the recorded event information to the workflow integration management apparatus which belongs to the same domain as that of the apparatus itself. The workflow integration management apparatus includes: an event association detecting device which detects association of each event specified by the event information acquired from each of the workflow execution apparatuses with respect to other events; and an event information recording device which records all of the event information acquired from each of the workflow execution apparatuses. The master workflow integration management apparatus includes, in addition to the event association detecting device and the event information recording device: a device which integrates a plurality of the workflows to generate an integrated workflow based on the workflow descriptions and the event information acquired from each of the workflow execution apparatuses and based on a detection result of the event association detecting device; and a device which transmits a replica of the integrated workflow to the subordinate workflow integration management apparatuses. The subordinate workflow integration management apparatus includes, in addition to the event association detecting device and the event information recording device, a device which receives the replica of the integration workflow from the master workflow integration management apparatus.

In order to achieve the foregoing object, a third aspect of the present invention provides a workflow integration management apparatus for tracking a workflow, which includes: an event association detecting device which, with respect to other events, detects association of each event specified by event information acquired from a plurality of workflow execution apparatuses for managing/executing a workflow; an event information recording device which records all of the event information acquired from each of the workflow execution apparatuses; a device which integrates a plurality of the workflows to generate an integrated workflow based on the workflow descriptions and the event information acquired from each of the workflow execution apparatuses and based on a detection result of the event association detecting device; and a device which transmits a replica of the integration workflow to the other workflow integration management apparatuses which do not have a device for generating the integrated workflow.

In order to achieve the foregoing object, a fourth aspect of the present invention provides a workflow integration management apparatus for tracking a workflow, which includes: an event association detecting device which, with respect to other events, detects association of each event specified by event information acquired from a plurality of workflow execution apparatuses belonging to a same domain as that of the apparatus itself for managing/executing a workflow; an event information recording device which records all of the event information acquired from each of the workflow execution apparatuses belonging to the same domain as that of the apparatus itself; a device which integrates a plurality of the workflows to generate an integrated workflow based on the workflow descriptions and the event information acquired from each of the workflow execution apparatuses belonging to the same domain as that of the apparatus itself and based on a detection result of the event association detecting device; and a device which transmits a replica of the integration workflow to the other workflow integration management apparatuses belonging to a different domain from that of the apparatus itself, which do not have a device for generating the integrated workflow.

In order to achieve the foregoing object, a fifth aspect of the present invention provides a workflow integration management method achieved by using a plurality of workflow execution apparatuses for managing/executing a workflow and a plurality of workflow integration management apparatuses for tracking the workflow. The method includes: a step which, by each of the workflow execution apparatuses, shows contents of events generated in the apparatus itself when executing an arbitrary workflow managed by the apparatus itself, and records peculiar event information by each of the events; a step which, by each of the workflow execution apparatuses, transmits a workflow description which shows contents of the workflow in a standardized data form to a single master workflow integration management apparatus that is determined in advance among the workflow integration management apparatuses; a step which, by each of the workflow execution apparatuses, transmits the recorded event information to a subordinate workflow integration management apparatus that is determined in advance for each of the workflow execution apparatuses; an event association detecting step which, by the workflow integration management apparatus, detects association of each event specified by the event information acquired from each of the workflow execution apparatuses with respect to other events; an event information recording step which, by the workflow integration management apparatus, records all of the event information acquired from each of the workflow execution apparatuses; a step which, by the master workflow integration management apparatus, integrates a plurality of the workflows to generate an integrated workflow based on the workflow descriptions and the event information acquired from each of the workflow execution apparatuses and a detection result of the event association detecting device; a step which, by the master workflow integration management apparatus, transmits a replica of the integrated workflow to the subordinate workflow integration management apparatuses other than the master workflow integration management apparatus; and a step which, by the subordinate workflow integration management apparatus, receives the replica of the integration workflow from the master workflow integration management apparatus.

In order to achieve the foregoing object, a sixth aspect of the present invention provides a workflow integration management method achieved by using a plurality of workflow execution apparatuses for managing/executing a workflow and a plurality of workflow integration management apparatuses for tracking the workflow. The method employs a hierarchical structure configured with a single master domain formed with the single master workflow integration management apparatus and at least a single workflow execution apparatus, and at least a single subordinate domain belonging to the master domain, which is formed with the single subordinate workflow integration management apparatus and at least a single workflow execution apparatus. The method includes: a step which, by each of the workflow execution apparatuses, shows contents of events generated in the apparatus itself when executing an arbitrary workflow managed by the apparatus itself, and records peculiar event information by each of the events; a step which, by each of the workflow execution apparatuses, transmits a workflow description which shows contents of the workflow in a standardized data form to the master workflow integration management apparatus; a step which, by each of the workflow execution apparatuses, transmits the recorded event information to a subordinate workflow integration management apparatus that belongs to a same domain as that of the apparatus itself; an event association detecting step which, by the workflow integration management apparatus, detects association of each event specified by the event information acquired from each of the workflow execution apparatuses with respect to other events; an event information recording step which, by the workflow integration management apparatus, records all of the event information acquired from each of the workflow execution apparatuses; a step which, by the master workflow integration management apparatus, integrates a plurality of the workflows to generate an integrated workflow based on the workflow descriptions and the event information acquired from each of the workflow execution apparatuses and a detection result of the event association detecting device; a step which, by the master workflow integration management apparatus, transmits a replica of the integrated workflow to the subordinate workflow integration management apparatuses; and a step which, by the subordinate workflow integration management apparatus, receives the replica of the integration workflow from the master workflow integration management apparatus.

In order to achieve the foregoing object, an eighth aspect of the present invention provides a computer-readable information recording medium to which the workflow integration management program is recorded.

It is possible with the present invention to overcome “issues regarding scalability limit caused due to achieving semantical integration in method with decentralized management concept used in work process tracking processing” without generating “issues regarding management inefficiency of methods with decentralized management concept used in work process tracking processing”.

### BEST MODES FOR CARRYING OUT THE INVENTIONS

### Principle of Present Invention

The present invention is a device which embodies the method for integrating and managing executions of the decentralized element workflow parts under an environment where a plurality of workflow management systems having respective workflow engines mounted thereon individually/dispersedly manages and keeps each element workflow part of the entire workflow which means a certain amount of work range conducted to maintain and control the startup states of a plurality of work application system groups and definitions of the operation order thereof. Particularly, the device efficiently overcomes the issues regarding the scalability generated in terms of the management technique. Therefore, the present invention is achieved by using following measures. Measure 1 and measure 2 are the devices taking over those of the related method, which are utilized for overcoming “issues regarding management inefficiency of the method with decentralized management concept used in work process tracking processing” described in FIG. 10. In order to overcome “issues regarding scalability limit caused due to achieving semantical integration in the method with decentralized management concept used in work process tracking processing” described in FIG. 9, measure 3 and thereafter are utilized in addition.

(Measure 1)

Following six element devices are combined to overcome the issue.
(1) An element device for collecting descriptions of decentralized element workflows.
(2) An element device for writing/managing the descriptions of the decentralized element workflows in a standard form that is designated in advance.
(3) An element device for converting the descriptions of the decentralized element workflows into the standard form.
(4) A workflow combining device for generating a description of the entire workflows by combining the descriptions of a plurality of decentralized element workflows.
(5) An event storing element device which clearly locates event groups generated as entities in the description of the entire workflows when performing the element workflow part, and registers those in an associated manner with respect to other event group.
(6) An element device for displaying the progress of the target entire workflows though a terminal by making an access to the event storage device.

(Measure 2)

An adapter processing device for converting a peculiar communication order of the work application system group to a standard communication order, when the workflow management system to which the workflow engine is mounted calls a group of a plurality of work application systems whose startup states and the definition of the operation order are maintained and controlled in the description of the entire workflows.

(Measure 3)

A device for forming organizations by employing a hierarchical structure to a plurality of decentralized workflow monitor systems. A concept of domain is employed for managing the plurality of workflow monitor systems. This makes it possible to limit the number of workflow systems managed by a unit workflow monitor system, and making association/relevancy by defining the hierarchical structure of a master-system distribute workflow monitor system and a subordinate-system decentralized workflow monitor system, etc., in a method equivalent to Domain Name System (DNS).

(Measure 4)

A communicating device which combines descriptions of the plurality of decentralized element workflows by the workflow combining device for generating the description of the entire workflows to generate integrated Wf definition and meta-information, and then copies a replica to the decentralized workflow monitor systems which manages each domain.

(Measure 5)

A communicating device for acquiring event information from the decentralized workflow system which manage another domain at a necessary timing, while referring to the integrated Wf definition and meta-information in the work process tracking processing. In this case, there are two methods depending on the character of the event information. One is a method which provides the information to the entire decentralized workflow monitor systems which manage other domains, and the other is a method which acquires only the necessary event information as necessary.

(Actions of Devices which Produce Effects)

Described hereinafter is how each measure overcomes “issues regarding scalability limit caused due to achieving semantical integration in the method with decentralized management concept used in work process tracking processing” and “issues regarding management inefficiency of the method with decentralized management concept used in work process tracking processing”.

For “issues regarding scalability limit caused due to achieving semantical integration in the method with decentralized management concept used in work process tracking processing”, the measures 1, 3, and 4 take over important roles, and the measure 2 provides the base part.

In order to implement the scalability, it is necessary to limit the number of workflow systems managed by the unit workflow monitor system. For that, it is necessary to have a scheme for achieving management in a hierarchical structure as achieved by the measure 3.

However, it is not possible to achieve semantical integration of the Wf definitions and meta-information by simply employing the decentralized structure, which results in becoming incapable of achieving the management. Therefore, it is necessary to: combine the descriptions of the plurality of decentralized element workflows to generate the integrated Wf definition and the meta-information by the three devices of the measure 1, i.e., (2) the element device for writing/managing the descriptions of the decentralized element workflows in a standard form that is designated in advance, (3) the element device for converting the descriptions of the decentralized element workflows into the standard form, and (4) the workflow combining device for generating a description of the entire workflows by combining the descriptions of a plurality of decentralized element workflows; and then to copy the replica by the measure 4 to the decentralized workflow monitor systems which manage each domain.

Through the above, it becomes possible to refer to the integrated Wf definition and meta-information at all times even under a decentralized environment. The workflows are rearranged as necessary, but not rearranged in a large scale daily. Therefore, the method employed with the measure 4 is the optimum in terms of the cost performance.

The measures 3, 4, and 5 take over important roles over “issues regarding management inefficiency of the method with decentralized management concept used in work process tracking processing”.

The management inefficiency that is the issue of FIG. 10 is caused due to the fact that the information is shared between N-number of systems. The central method as in FIG. 9 is desirable for overcoming it efficiently. However, there is an issue of scalability with that method.

In general, monitor data regarding the events can be classified into three kinds, i.e., alert data that is to be immediately distributed according to a management level, tracking data that is referred in a short-to-medium term, and monitoring data that is referred in a long term.

The work process tracking target is mostly the tracking data that is referred in a short-to-medium term, while there partially exits the tracking data to be distributed immediately. Thus, it is not something that needs to be distributed constantly. It is possible to satisfy a necessary requirement by giving a priority to the method which acquires only the necessary part as necessary.

Through the above, the use of the measure 5 makes it possible to acquire the event group regarding a necessary and corresponding message and the event group regarding the message in the engine on demand as necessary. Therefore, the efficiency in terms of the management can be increased.

### First Exemplary Embodiment

FIG. 1 is an illustration showing an outline of an overall structure of a first exemplary embodiment of the invention. FIG. 1 is illustrated focusing on a work process tracking apparatus based on a decentralized workflow management/collection method used for a large-scaled operation, which is a part of the present invention. The work process tracking apparatus based on the decentralized workflow management/collection method is configured, including: a plurality of arbitrary workflow systems 1 (marked as WfMS_1), 2 (marked as WfMS_2), 3 (marked as WfMS_3) based on the decentralized workflow management system; a master-system workflow monitor system 4 (marked as DsWfMS_1) which collects various kinds of event information from the workflow systems 1, 2, etc., and then arranges, integrates, and stores the information; a plurality of arbitrary subordinate-system decentralized workflow monitor systems 5 (marked as DsWfMS_2), 57 (marked as DsWfMS_3), and 58 (marked as DsWfMS_N) which collect various kinds of event information from the workflow system 3 and the others, and then arranges, integrates, and stores the information; and client sites 6 and 54 by Web browsers as client systems for making an access to arbitrary decentralized workflow monitor systems of master-system or subordinate-system. There is a hierarchical structure similar to that of DNS (described later) existed in the master-system decentralized workflow monitor system 4 (marked as DsWfMS_1), the plurality of arbitrary subordinate-system workflow monitor systems 5, 57, and 58, and there are associative relations existing mutually.

In FIG. 1, the workflow system 1 communicates with a plurality of work application systems 7 (marked as AP_A) and 8 (marked as AP_B). Further, the workflow system 2 communicates with a plurality of work application systems 9 (marked as AP_C) and 10 (marked as AP_D).

In order to achieve the above, the work application system 7 includes a data communication part 11 (marked as COM_A). Further, the work application system 8 includes a data communication part 12 (marked as COM_B).

Similarly, the work application system 9 includes a data communication part 13 (marked as COM_C). Further, the work application system 10 includes a data communication part 14 (marked as COM_D)

In the meantime, the workflow system 1 includes an adapter 15 (marked as AD1_A) for performing communication with the data communication part 11 and another adapter 16 (marked as AD1_B) for performing communication with the data communication part 12. These adapters convert disparities on communication protocols and operational disparities when the work application system 7 and the work application system 8 perform necessary communication, as a result of a control in the operation orders performed by a workflow engine 23 (marked as WfE_1) included in the workflow system 1.

Similarly, the workflow system 2 includes an adapter 17 (marked as AD2_C) for performing communication with the data communication part 13 and another adapter 18 (marked as AD2_D) for performing communication with the data communication part 14. These adapters convert disparities on communication protocols and operational disparities when the work application system 9 and the work application system 10 perform necessary communication, as a result of a control in the operation orders performed by a workflow engine 26 (marked as WfE_2) included in the workflow system 2.

The behavior of the workflow engine 23 is defined in a workflow definition 25 (marked as Wf definition_1) included in the workflow system 1. The definition regulates what state the workflow engine 23 comes to go under, and what kinds of processing request and processing response message the workflow engine 23 issues, when there are events generated related to a processing request and a processing response message from the other decentralized workflow systems 2, 3, etc., and also events occurred related to a processing request and a processing response message generated as a result of communication performed between a plurality of work application systems 7 and 8. Normally, the workflow definition 25 describes only the behavior of the workflow engine 23 in forms of process descriptions such as standardized forms of WS-BPEL and WSDL.

The behavior of the workflow engine 26 is defined in a workflow definition 28 (marked as Wf definition_2) included in the workflow system 2. The definition regulates what state the workflow engine 26 comes to go under, and what kinds of processing request and processing response message the workflow engine 26 issues, when there are events generated related to a processing request and a processing response message from the other decentralized workflow systems 1, 3, etc., and also events occurred related to a processing request and a processing response message generated as a result of communication performed between a plurality of work application systems 9 and 10. Normally, the workflow definition 28 describes only the behavior of the workflow engine 26 in forms of process description such as standardized forms of WS-BPEL and WSDL.

The events related to the processing request and processing response message generated in the workflow system 1 are detected by a plurality of event extracting parts provided within the workflow system 1. Communications between the data communication part 11 and the adapter 15 are all detected by an Msg event extracting part 19 provided inside the adapter 15. Similarly, communications between the data communication part 12 and the adapter 16 are all detected by an Msg event extracting part 20 provided inside the adapter 16. The behavior of the workflow engine 23 is detected by an Eng event extracting part 24.

Event information extracted by the Msg event extracting part 19, the Msg event extracting part 20, and the Eng event extracting part 23 is temporarily stored in an event data keeping part 29 within the workflow system 1, and it is transferred to the decentralized workflow monitor system 4 by a common data transmitting part 30 as appropriate.

To which of the decentralized workflow monitor systems the event information is transferred is determined depending on a domain defined by the decentralized workflow monitor system. The workflow system 1 works under the master-system decentralized work monitor system 4, so that the event information is transferred to the master-system decentralized work monitor system 4. Relations regarding the domain, the decentralized work monitor system, and the workflow system will be described later by using FIG. 8.

The events related to the processing request and processing response message generated in the workflow system 2 are detected by a plurality of event extracting parts provided within the workflow system 2. Communications between the data communication part 13 and the adapter 17 are all detected by an Msg event extracting part 21 provided inside the adapter 17. Similarly, communications between the data communication part 14 and the adapter 18 are all detected by an Msg event extracting part 22 provided inside the adapter 18. The behavior of the workflow engine 26 is detected by an Eng event extracting part 27.

Event information extracted by the Msg event extracting part 21, the Msg event extracting part 22, and the Eng event extracting part 27 is temporarily stored in an event data keeping part 31 within the workflow system 2, and it is transferred to the decentralized workflow monitor system 4 by a common data transmitting part 32 as appropriate.

As described above, to which of the decentralized workflow monitor systems the event information is transferred is determined depending on a domain defined by the decentralized workflow monitor system. The workflow system 2 also works under the master-system decentralized work monitor system 4, so that the event information is also transferred to the master-system decentralized work monitor system 4. Further, when the workflow system 3 works under the subordinate-system workflow monitor system 5, the event information within the workflow system 3 is not sent to the master-system decentralized workflow monitor system 4 but sent to the subordinate-system workflow monitor system 5 from a common data transmitting part 33. Relations regarding the domain, the decentralized work monitor system, and the workflow system will be described later by using FIG. 8.

The master-system decentralized workflow monitor system 4 includes: a Wf definition/service definition acquiring part 51 which receives the workflow definition 25, the workflow definition 28, and the other workflow definition 56 (marked as Wf definition_3, see FIG. 3), and applies conversion partially; a Wf combining part 50 which forms an integrated workflow definition from all the workflow definitions acquired by the Wf definition/service definition acquiring part 51; and a combined Wf definition 34 which stores and manages the combined workflow definition.

Especially, the Wf definition/service definition acquiring part 51 is capable of making an access to a repository 52 placed outside.

Furthermore, the master-system decentralized workflow monitor system 4 also includes: an event data receiving part 38 which receives all the data related to the event from the workflow system 1 and the workflow system 2; an event storage part DB 42 which arranges all the event data received at the event data receiving part 38, and keeps the data in a related manner by referring to the combined Wf definition 34; and an event data associating part 40 which performs actual processing for associating the data.

Moreover, the master-system decentralized workflow monitor system 4 also includes: an AP label entering part 53 which is an application for defining and naming work-related labels for the data within the combined Wf definition 34; a searching function part 36 which is an application for searching event data that corresponds to a given condition, based on the combined Wf definition 34; a tracking display creating part 44 which displays the event data in a time series manner by relating the data within the combined Wf definition 34 to the result returned from the searching function part 36; and a batching part 46 which performs statistical processing and evaluation processing based on the data stored and managed in the event storage DB 42.

Further, the master-system decentralized workflow monitor system 4 also includes a communication base part 48 which provides a base for communications with the subordinate-system decentralized workflow monitor system 5. The communication base part 48 is used when the replica of the combined Wf definition 34 is distributed to the subordinate-system decentralized workflow monitor system 5 and when the searching function part 37 within the subordinate-system decentralized workflow monitor system 5 transmits a query.

The master-system decentralized workflow monitor system 4 and the subordinate-system decentralized workflow monitor systems 5, 57, 58 have respective domains for regulating respective managing ranges. In the domain, the hierarchical structure is so defined that one of the plurality of arbitrary workflow systems 1, 2, and 3 belongs thereto according to the decentralized workflow management method, and the relevancy of the systems are defined. A method equivalent to DNS is employed as a specific achieving method thereof.

FIG. 8 shows an example of a structural relation regarding the domains, the decentralized workflow monitor systems, and the workflow systems when the method equivalent to DNS is employed. The work application system 7 and the work application system 8 have communicating relations c100 and c101 with the workflow system 1. Specifically, these correspond to a processing request message c2, a processing response message c3, and the like, which will be described later.

Further, the work application system 9 and the work application system 10 have communicating relations c102 and c103 with the workflow system 2. Specifically, these correspond to a processing request message c6, a processing response message c7, and the like, which will be described later.

There are also communicating relations c104, c105, and c106 among the workflow system 1, the workflow system 2, and the workflow system 3. Specifically, these correspond to a processing request message c21, a processing response message c22, and the like, which will be described later.

The master-system decentralized workflow monitor system 4 forms domains, and specifies the workflow system 1 and the workflow system 2 belonging thereto. The specified relation is managed as relations c107 and c108. A specific management method thereof is depicted and kept in a domain definition table 80 provided to the master-system workflow monitor system 4.

The subordinate-system decentralized workflow monitor system 5 also forms a domain, and specifies the workflow system 3 belonging thereto. The specified relation is managed as a relation c109. A specific management method thereof is also depicted and kept in a domain definition table 81 provided to the subordinate-system workflow monitor system 5.

As described above, the domains have a hierarchical structure in terms of management. There is the hierarchical structure between the domain of the master-system decentralized workflow monitor system 4 and the domain of the subordinate-system workflow monitor system 5, and it is maintained as a relation c112. Since there is the hierarchical structure, there is also a hierarchical structure between the domain of the master-system decentralized workflow monitor system 4 and the domain of another subordinate-system workflow monitor system 57, and it is maintained as a relation c111.

Similarly, there is a “slave to sub-slave” hierarchical structure between the domain of the subordinate-system decentralized workflow monitor system 5 and the domain of the subordinate-system workflow monitor system 58, and it is maintained as a relation c113. A “slave to sub-slave” hierarchical structure with another arbitrary subordinate-system decentralized workflow monitor system is maintained as a relation c114.

In the hierarchical structure, the master-system decentralized workflow monitor system 4 is defined as being in the highest order, whereas the subordinate-system decentralized workflow monitor systems 5 and the like are defined as being in the orders other than the highest order in the hierarchical structure. Thus, there is only one master-system decentralized workflow monitor system 4 on the whole, whereas there possibly be a plurality (one or more) of the subordinate decentralized workflow monitor systems 5 and the like.

In order to maintain the hierarchical structure, the relations c111, c112, c113, and c114 are maintained among each of the decentralized workflow monitor systems. Those relations are maintained and managed by the respective domain definition tables provided to each of the decentralized workflow monitor systems. The master-system decentralized workflow monitor system 4 holds the domain definition table 80 internally.

Further, the subordinate-system decentralized workflow monitor system 5 holds the domain definition table 81 internally. Furthermore, the subordinate-system decentralized workflow monitor system 57 holds the domain definition table 82 internally. Moreover, the subordinate-system decentralized workflow monitor system 58 holds the domain definition table 83 internally. This also applies if there is another subordinate-system decentralized workflow monitor system.

The domain definition table 80, the domain definition table 81, the domain definition table 82, and the domain definition table 83 may be implemented as tables on a database or may be implemented in a definition files. A case of employing a definition file form will be described herein by referring to the domain definition table 81.

Including the domain definition table 81, all the domain definition tables are configured with four large elements. The first element is a domain-name definition 84, the second element is a master-domain definition 83, the third element is a list 86 regarding the definitions of the subordinate domains, and the last element is a list 87 regarding the workflow system group belonging to the domains.

When the definition file form is employed, the four elements are expressed with character strings, and each element specification is sectioned with a delimiter “;”. The domain-name definition 84 is given in a character string after a variable with a fixed identifier, “domainname”.

The master-domain definition 85 means the highest-order domain. In this case, it means the domain of the master-system decentralized workflow monitor system 4. When designating this, a character string of the master-domain name is designated after a variable with a fixed identifier, “primarydomain” (the master-domain definition), and a character string of address information of the master-system workflow monitor system 4 which manages the master domain is designated after a space. The address information character string is an IP (Internet Protocol) address character string, a URI (Uniform Resource Identifier) character string, or a domain-name character string.

The definition 87 of the workflow system group belonging to the domain means a group of the workflow systems which belong to the domain. When designating it, a character string of a list structure having a medium parenthesis capable of depicting a plurality of entries is designated after a variable with a fixed identifier, “ownedworkflow” (the workflow definition). In this case, only “3” belongs, so that the server identifier and the address information character string thereof are designated. The address information character string is an IP (Internet Protocol) address character string, a URI (Uniform Resource Identifier) character string, or a domain-name character string.

Through the above method, it becomes possible to achieve the management method with scalability which is directed to a large-scale operation.

Further, the master-system decentralized workflow monitor system 4 is not defined only as the highest-order function in the hierarchical structure shown in FIG. 8. The master-system decentralized workflow monitor system 4 is the only system that is provided with the Wf combining part 50 which receives the workflow definition 25, the workflow definition 28, and the workflow definition 56 and combines those into an integrated workflow definition, and also works to keep, as an original copy, the combined Wf definition 34 in which the combined workflow definition is stored and managed.

In the meantime, the subordinate-type decentralized workflow monitor system 5 only has a partial function of the structural function of the master-system decentralized workflow monitor system 4. For example, the subordinate-type decentralized workflow monitor system 5 has a combined Wf definition 35 which is not the original copy of the combined Wf definition 34 but its perfect replica. However, the combined Wf definition 35 includes the address information indicating the positions of the master-system decentralized workflow monitor system 4 and the like, so that it is the replica with additional information. The updating procedure thereof will be described later by referring to FIG. 4.

Now, the structure of the subordinate-system decentralized workflow monitor system 5 will be described. The subordinate-system decentralized workflow monitor system 5 includes a communication base part 49. Through this part, the combined Wf definition 35, which is acquired by adding the address information to the replica of the combined Wf definition 34, is transferred.

Therefore, the subordinate-system decentralized workflow monitor system 5 does not require a function part which corresponds to the Wf combining part 50. Further, the subordinate-system decentralized workflow monitor system 5 does not have a function part which corresponds to the AP label entering part 53 and a function part which corresponds to the Wf definition/service definition acquiring part 51.

Furthermore, the subordinate-system decentralized workflow monitor system 5 also includes: an event data receiving part 39 which receives all the data related to the events generated within the managing domains; an event storage DB 43 which arranges all the event data received at the event data receiving part 39, and keeps the data in a related manner by referring to the combined Wf definition 35 that is the replica; and an event data relating part 41 which performs actual processing for associating the data.

Moreover, the subordinate-system decentralized workflow monitor system 5 also includes: a searching function part 37 which is an application for searching event data that corresponds to a given condition, based on the combined Wf definition 35; a tracking display creating part 45 which displays the event data in a time series manner by relating the data within the combined Wf definition 35 to the result returned from the searching function part 37; and a batching part 47 which performs statistical processing and evaluation processing based on the data stored and managed in the event storage DB 43.

In order to operate the tracking display creating part 44 of the searching function part 36, or the searching function part 37 and the tracking display creating part 45, it is necessary to start up a Web browser for defining specific meanings to the various kinds of events. For that, it is necessary to start up at least one client site 6.

(Explanation Regarding Operations)

The outline of the procedure when collecting event information from typical dispersedly-placed workflow engines will be described by referring to FIG. 2. Explanations will be provided herein by referring to a case of the domain defined by the master-system decentralized workflow monitor system 4.

When the workflow engine 23 communicates with the work application system 7, the workflow engine 23 sends a processing request message c1 to the adapter 15 according to the workflow definition 25. There may be cases where the processing request message c1 is provided by a Web service or the like, and it is defined with XML (Extensible Markup Language) or the like.

The adapter 15 converts the process request message c1 to be in a communication protocol and procedure so as to be received at the work application system 7, and sends it as a new processing request message c2 to the data communication part 11 within the work application system 7.

The data communication part 11 receives the processing request message c2, and gives it to the work application system 7. As a result, if necessary, a new processing response message c3 is generated, and it is returned to the adapter 15 from the data communication part 11.

The adapter 15 converts the result to be in a communication protocol and a procedure regulated in advance, and returns it to the workflow engine 23 as a processing response message c4.

The workflow engine 23 determines a next behavior according to the workflow definition 25. As a result, when communicating with the work application system 8, the workflow sends a processing request message c5 to the adapter 16 this time according to the workflow definition 25. The processing request message c5 may also be provided by a Web service or the like, and it is defined with XML or the like.

The adapter 16 converts the process request message c5 to be in a communication protocol and procedure so as to be received at the work application system 8, and sends it as a new processing request message c6 to the data communication part 12 within the work application system 8.

The data communication part 12 receives the processing request message c6, and gives it to the work application system 8. As a result, if necessary, a new processing response message c7 is generated, and it is returned to the adapter 16 from the data communication part 12.

The adapter 16 converts the result to be in a communication protocol and a procedure regulated in advance, and returns it to the workflow engine 23 as a processing response message c8.

The workflow engine 23 determines a next behavior according to the workflow definition 25, and there is a case where the workflow engine communicates with another workflow system 2. In that case, the workflow engine 23 sends a processing request message c21 to that workflow system 2 this time, according to the workflow definition 25. The processing request message c21 may also be provided by a Web service or the like, and it is defined with XML or the like.

A result of the processing request message c21 is returned to the workflow engine 23 as a processing response message c22.

The events related to the processing request and the processing response message generated in the workflow system 1 are extracted by a plurality of event extracting parts provided dispersedly within the workflow system 1. Specifically, the Msg event extracting part 19 is provided to the adapter 15.

At the point where the adapter 15 receives the processing request message cl, the Msg event extracting part 19 detects it and records it as an event c17 related to the message. Further, at the point where the adapter 15 converts the processing request message c1 to be in the communication protocol and the procedure so as to be received at the work application system 7 and transmits it as the processing request message c2, the Msg event extracting part 19 detects it and records it as an event c18 related to the message.

Similarly, at the point where the adapter 15 receives the processing response message c3 from the data communication part 11, the Msg event extracting part 19 detects it and records it as an event c19 related to the message. Further, at the point where the adapter 15 converts the processing response message c3 to form a processing response message c4 and sends it to the workflow engine 23, the Msg event extracting part 19 detects it and records it as an event c20 related to the message.

Similarly, the adapter 16 is provided with the Msg event extracting part 20.

The Msg event extracting device 20 detects the processing request message c5 and records it as an event c13 related to the message, in the same manner as the case of the Msg event extracting part 19. In addition, the Msg event extracting device 20 detects the processing request message c6 and records it as an event c14 related to the message. Furthermore, the Msg event extracting device 20 detects the processing response message c7 and records it as an event c15 related to the message. Moreover, the Msg event extracting device 20 detects the processing response message c8 and records it as an event c16 related to the message.

The behaviors of the workflow engine 23 are detected by the Eng event extracting part 24. The Eng extracting part 24 handles a series of all the events related to the messages generated by the workflow engine 23 and the received messages.

For example, the Eng event extracting part 24 detects the processing request message c1 that is given to the adapter 15, and records it as an event c9 related to the message in the engine. Similarly, the Eng event extracting part 24 detects the processing response message c4 that is given from the adapter 15, and records it as an event c10 related to the message in the engine.

Further, the Eng event extracting part 24 detects the processing request message c5 that is given to the adapter 16, and records it as an event c11 related to the message in the engine. Similarly, the Eng event extracting part 24 detects the processing response message c8 that is given from the adapter 16, and records it as an event c12 related to the message in the engine.

Further, this is the same when communicating with another workflow system 2. The Eng event extracting part 24 detects the processing request message c21 that is sent to the workflow system 2, and records it as an event c23 related to the message in the engine. Furthermore, the Eng event extracting part 24 also detects the processing response message c22 that is returned for the result of the processing request message c21, and records it as an event c24 related to the message in the engine.

When recording each of the events c17, c18, c19, c20 which are the events related to the messages recorded by the Msg event extracting part 19, the events c13, c14, c15, c16 which are the events related to the messages recorded by the Msg event extracting part 20, and the events c9, c10, c11, c12, c23, c24 which are the events related to the messages in the engine detected by the Eng event extracting part 24, each event is recorded in the event data holding part 29 within the workflow system 1 and temporarily saved. Thereafter, the common data transmitting part 30 generates an event data transfer message c25 in a regulated format, and transfers it to the master-system workflow monitor system 4 as appropriate. To which of the decentralized workflow monitor systems the message is sent is determined according to the domains defined by the decentralized workflow monitor systems. The workflow system 1 shown in FIG. 2 is a subordinate of the master-system workflow monitor system 4, so that the event data transfer message c25 is transferred accordingly.

The master-system workflow monitor system 4 has the event data receiving part 38 for receiving all the data related to the events, and it receives the event data transfer message c25.

FIG. 3 shows an outline of a procedure which is executed when collecting a group of workflow definitions (referred to as “Wf definitions” hereinafter) individually kept in the dispersedly-placed workflow engines into the master-system decentralized workflow monitor system, and generating an integrated/combined Wf definition. Collecting the group of Wf definitions is one of the main functions of the master-system decentralized workflow monitor system, so that the way thereof is different from the case of the event data transfer message c25.

The behavior of the workflow engine 23 included in the workflow system 1 and illustrated in FIG. 2 is defined in the workflow definition 25. Normally, the workflow definition 25 only describes the behaviors of the workflow engine 23, and it is written by using a standard form such as WS-BPEL and WSDL.

The behavior of the workflow engine 26 included in the workflow system 2 and illustrated in FIG. 2 is defined in the workflow definition 28. Normally, the workflow definition 28 only describes the behaviors of the workflow engine 26, and it is written by using a standard form such as WS-BPEL and WSDL.

The workflow definition 25 is transferred to the Wf definition/service definition acquiring part 51 within the master-system workflow monitor system 4 as a definition transfer message c50 as appropriate, and the workflow definition 28 is transferred as a definition transfer message c51 as appropriate. Further, like the workflow definition 25 and the workflow definition 28, there is also a workflow definition 56 in the workflow system 3. Unlike the case of the above-described event data transfer message c25, the workflow definition 56 is transferred as a definition transfer massage c52 not to the subordinate-system decentralized workflow monitor system 5 but to the Wf definition/service definition acquiring part 51 within the master-system decentralized workflow monitor system 4.

When the Wf definition/service definition acquiring part 51 receives the definition transfer messages c50, c51, and c52, the workflow definitions 25, 28, and 56 are all saved after being verified that those are written in a standardized form such as WS-BPEL and WSDL. In that case, the definitions may be saved in the repository 52 placed outside.

Inside the master-system decentralized workflow monitor system 4, there is the Wf combining part 50 which combines the integrated workflow definition from all the workflow definitions 25, 28, 56, and the like acquired by the Wf definition/service definition acquiring part 51, and there is the combined Wf definition 34 in which the combined workflow definition is stored and managed.

The Wf combining part 50 starts up the Wf definition/service definition part 51 at all times in order to acquire all the workflow definitions to be the elements. The Wf definition/service definition part 51 acquires all the workflow definition information to be the elements already held internally, and also acquires all the remaining workflow definition information which is possible to become the elements by making an inquiry c53 to the repository 52.

Thereafter, the Wf definition/service definition part 51 gives all the necessary definition information 25, 28, and 56 to the Wf combining part 50 as c54. The Wf combining part 50 generates a combined result c56 of the integrated/combined workflow definition through a procedure depicted in a preceding Application or the like, for example. The Wf combining part 50 gives the combined result c56 to the combined Wf definition 34 to keep it within the combined Wf definition 34.

Service definition/process definition information generated by the Wf combining part 50 is structured to include a process definition, a definition part, an activity part, a service definition, a message definition part, a port definition part, a binding part, a service definition part, and the like according to WX-BPEL and WSDL. Those are written in computer-readable expressions which hardly carry semantic information in a direct manner.

Therefore, the master-system decentralized workflow monitor system 4 is provided with the AP label entering part 53 for adding semantic information/expression information on the application to the service definition/process definition information within the combined Wf definition 34 that is generated by the Wf combining part 50. The user (mainly the system administrator) starts up a single client site 54 or more to start up the AP label entering part 53.

Semantic information/expression information c61 operated and inputted via the client site 54 is given to the AP label entering part 53. Thereafter, the AP label entering part 53 issues an operation request 58 to add the semantic information/expression information c61 as annotations to the process definition, the definition part, the activity part, the service definition, the message definition part, the port definition part, the binding part, the service definition part, and the like by referring to the combined Wf definition 34.

A form of implementing the combined Wf definition 34 will be described by referring to FIG. 7. FIG. 7 is an illustration showing a data structure and management structure for configuring the combined Wf definition 34 and the event storage DB 42, assuming a case where only the necessary main parts for embodying the present invention are mounted to a database management system.

In the drawing, a part 75 surrounded by an alternate long and short dash line is a part corresponding to the combined Wf definition such as the combined Wf definition 34 and the combined Wf definition 35. In this part, a combined workflow definition description table 60, a workflow/process definition description table 61, a service call activity definition table 62, a service definition table 63, and the like are included.

In the drawing, a part 76 surrounded by a double-dot dash line is a part corresponding to the event storage DB part such as the event storage DB 42 and the event storage DB 43. In this part, a combined process executing instance management table 64, a process executing instance management table 65, a service event management table 66, a statistical data management table 67, and the like are included.

The combined workflow definition description table 60 keeps the main part of the combined result c56 generated by the Wf combining part 50. In the meantime, the workflow process definition description table 61, the service call activity definition table 62, and the service definition table 63 manage the workflow definition 25, the workflow definition 28, and the workflow definition 56 written in WS-BPEL and WSDL in equivalent expressions.

The workflow process definition description table 61 manages the part related to the process definition in WS-BPEL. The service call activity definition table 62 manages the part related to the activity definition and the call service in WS-BPEL. The service definition table 63 manages the part related to the service written in WSDL.

There are items 68, 68′, and 68″ regarding “+ AP label explanation description, + display label description” provided in the workflow process definition description table 61, the service call activity definition table 62, and the service definition table 63. These are the storage areas for annotations of the semantic information and expression information given to the process definition, the definition part, the activity part, the service definition, the message definition part, the port definition part, the binding part, the service definition part, and the like through the AP label entering part 53.

There are items 69 and 69′ related to “+ placed domain section (own domain, other domain)” provided in the service call activity definition table 62 and the service definition table 63. This shows whether the workflow system containing the corresponding workflow definition is in the own domain or in other domains. This is the part which receives change/update along with the “assigned domain monitor address” according to the decentralized workflow monitor system, when the master-system decentralized workflow monitor system 4 distributes the replica to the subordinate-system decentralized workflow monitor system 5, as will be described later. Therefore, the master-system decentralized workflow monitor system 4 and the subordinate-system decentralized workflow monitor system 5 have different values. In the outline of the procedure for grasping and searching the execution state of the workflow defined in FIG. 6, the searching function part 37 performs the processing for acquiring a list of the event group related to the corresponding message managed in the other decentralized workflow monitor system and the event group related to the message in the engine based on the information.

The combined process execution instance management table 64 manages the actual execution state of the integrated/combined workflow definition defined in the combined workflow definition description table 60. It is possible that a plurality of executions are conducted for the same definition within a given time. In the meantime, the process execution instance management table 65 starts up to manage the behavior/execution state of each workflow engine under the actual executing state of the integrated/combined workflow definition.

The service event management table 66 manages a series of events generated in each workflow engine. The last statistical data management table 67 manages a result value c63 (described later) inside the batching part 46 and the batching part 47 which are started up at every designated time.

When a series of operations in the Wf combining part 50 and the AP label entering part 53 ends, the master-system workflow monitor system 4 calls the communication base part 48 for sending and creating corresponding information containing the perfect replica of the combined Wf definition 34 to a plurality of subordinate decentralized workflow monitor system 5, 57, and 58, since the integrated/combined Wf definition and meta-information are updated. FIG. 4 shows the procedure thereof.

Upon receiving an original information c65 for creating the corresponding information containing the perfect replica of the combined Wf definition 34, the communication base part 48 sequentially calls the communication base parts of a plurality of the subordinate-system decentralized workflow monitor systems 5, 57, and 58 to send it thereto. FIG. 4 shows a case of calling the communication base part 49 within the subordinate-system decentralized workflow monitor system 5. When making the call, a transaction request c66 containing the original information c65 is transferred.

When the communication base part 49 receives the transaction request c66, the communication based part 49 conducts an update processing proceeding c67 to create the combined Wf definition 35 including the address information indicating the positions of the master-system decentralized workflow monitor system 4 and the like, the address information indicating the positions of the workflow system 1, the workflow system 2, and the workflow system 3, the address information indicating the positions of the subordinate-system decentralized workflow system 5 and the like which manage the domains, and the address information indicating the positions of the master-system decentralized workflow monitor system 4 and the like, based on the corresponding information of the perfect replica of the combined Wf definition 34.

The “+ assigned workflow system definition ID”, “+ assigned address: URL description”, “+ placed domain section”, “+ placed domain monitor system definition ID”, “+ placed domain monitor address: URL description”, and the like within the workflows and the process definition description table 61 defined in FIG. 7 correspond to the address information.

The update proceeding c67 is executed in a following procedure. When there is no existing record or the like of the combined Wf definition 35, a new record is created in the combined Wf definition 35 by using the original information c65 within the transaction request c66. In the meantime, when there is an existing record of the combined Wf definition 35, the existing record and the original information c65 within the transaction request c66 are compared to perform provisional update of the updated part. When the contents are simply updated, provisional update is performed in a corresponding manner. When a part of the contents is being canceled, provisional processing is performed to invalidate the corresponding part, etc. Through such processing, a provisional version of the combined Wf definition 35 is created.

If there is no specific problem found during the execution of the update proceeding c67, the communication base part 49 performs committing processing to finalize the provisional version of the combined Wf definition 35. In the meantime, if there is a problem found during the execution of the update proceeding c67, the communication base part 49 performs abort processing to discard the provisional version of the combined Wf definition 35 and maintains the former version.

The processing regarding creation and update of the combined Wf definition 35 is performed within a single transaction range. Thus, when the processing is completed, the communication base part 49 returns a transaction request result c68 to the communication base part 48 of the master-system decentralized workflow monitor system 4.

If there is no problem detected when the communication base part 48 receives the transaction request result c68, a communication base part of another subordinate-system decentralized workflow monitor system is successively called to send and create corresponding information including the perfect replica of the combined Wf definition 34, and sends another transaction request c70 including the original information c65.

If there is a problem detected when the communication base part 48 receives the transaction request result c68, the communication base part 48 sends an alarm c69 indicating that there is a problem. At the same time, the communication base part 48 skips the subordinate-system decentralized workflow monitor system 5 and calls the communication base part of another subordinate-system workflow monitor system to send the transaction request c70 including the original information c65. The post-processing of the transaction request c66 for the subordinate-system decentralized workflow monitor system 5 having the problem cannot be regulated to a standardized method, because of the operational conditions. However, it is one of the methods to resend a series of transaction requests including the original information c65 after performing the processing to all the subordinate-system decentralized workflow monitor systems.

FIG. 5 is an illustration showing an outline of a procedure when updating the execution state of the workflow by using the integrated/combined Wf definition and meta-information after distributing those definition and the information. This case includes two kinds of processing. One is an update processing procedure of the execution state limited to the domain related to a given workflow system. The other one is an update processing procedure when starting update for the entire combined Wf definition.

FIG. 6 is an illustration showing an outline of a procedure when grasping and searching the execution state of the workflow by using the integrated/combined Wf definition and meta-information after distributing those definition and the information. This case also includes two kinds of processing. One is the processing for grasping and searching the execution state of the workflow from the decentralized workflow monitor system. The other is the processing which searches the execution state of the workflow from another decentralized workflow monitor system, and stores the search result as a cache to the decentralized workflow monitor system which conducted the search.

First, among the updates of the execution state of the workflow in FIG. 5, the update of the execution state limited to the domain related to a given workflow system will be described by referring to a case of the master-system decentralized workflow monitor system 4.

The event information extracted by each of the event extracting parts of the workflow system 1 and the workflow system 2 is transferred to the master-system decentralized workflow monitor system 4 as event data transfer messages c25 and c26 from the common data transmitting part 30 and the common data transmitting part 32 as appropriate. The event data receiving part 38 in the master-system workflow monitor system 4 receives the event data transfer messages c25 and c26.

The event data receiving part 38 gives all the data c55 regarding the event to the event data associating part 40. The event data associating part 40 refers to the combined Wf definition 34 while searching and referring to the service definition/process definition information c57 managed internally to arrange correspondence of each of all the data c55 related to the event, and associates those with the respective message instances of the service processes. At the same time, the event data associating part 40 searches a message instance group c60 managed currently in the event storage DB 42, and associates the instances to the data c55. Thereafter, it is stored in the event data DB 42 as a new message instance record c59. The message instance record c59 is normally in the service event management table 66 shown in FIG. 7. However, when the record also carries the start of the process and the like, it is also included in the record groups of the combined process execution instance management table 64 and the process execution instance management table 65. Therefore, when making relevancy, it is performed to maintain the data structure regarding the database of FIG. 7.

This update of the execution state limited to the domain related to the workflow system is not only for the case of the master-system decentralized workflow monitor system 4 but also corresponds to the case of the subordinate-system workflow monitor system 5.

When the entire combined Wf definition is to be started at the time of storing the new message instance record c59 to the event storage DB 42, special processing is added further. An update proceeding for starting the entire combined Wf definition will be described hereinafter.

When performing execution of a combined process anew based on the combined Wf definition, it is possible that the processes are combined not only within the domain defined by a single workflow monitor system but over a plurality of domains. Therefore, when starting the entire combined Wf definition anew, it is notified to all the event storage DBs of the decentralized workflow monitor systems managing each domain by a broadcast replica that execution of combining the processes occurred anew.

When the record c59 for starting the combined Wf definition anew is stored in the event storage DB 42 within the master-system decentralized workflow monitor system 4 (particularly in the combined process execution instance management table 64 of FIG. 7), the communication base part 48 is called for creating an equivalent record as a replica in the event storage DB 43 within another subordinate-system decentralized workflow monitor system 5 by using a database trigger function or the like.

Upon receiving a replica request c93 regarding the record c59 for starting the entire combined Wf definition anew from the event storage DB 42, the communication base part 48 sequentially calls the communications base parts of a plurality of subordinate-system decentralized workflow monitor systems 5 and the like working thereunder to send the replica request c93 thereto. In FIG. 5, the communication base part 49 within the subordinate decentralized workflow monitor system 5 is called. When making a call, send is a replica creating transaction request c94 which contains the information within the replica request c93.

When the communication base part 49 receives the replica creating transaction request c94, the communication base part 49 conducts a creation proceeding c95 for creating a record in the combined process execution instance management table 64 within the event storage DB 43, based on the corresponding information of the replica of the combined Wf definition 35.

The creation proceeding c95 is executed in a following procedure. When there is no corresponding record, a definition ID is designated with a combination of specific information of the workflow system that is the start point of conducting the entire combined Wf definition anew and a unique combined process instance managed within the start workflow system to provisionally create a record having that value. This corresponds to “72” of FIG. 7. When there is a corresponding record, it is not treated as an error. The number of updates of the replica is incremented by 1 to provisionally create a record that is equivalent to the corresponding record. Through this, the record of the replica can be updated at a point where there is a change in the execution state of the combined process.

When no problem is detected during the execution of the creation proceeding c95, the communication base part 49 performs committing processing to finalize the provisional record in the combined process execution instance management table 64 within the event storage DB 43 as a new record. In the meantime, if there is a problem found during the execution of the creation proceeding c65, the communication base part 49 performs abort processing to discard the provisional record of and maintains the former state.

The processing for creating the new record in the combined process execution instance management table 64 within the event storage DB 43 is performed in a single transaction range. Thus, after completing the processing, the communication base part 49 returns a replica creating transaction request result c96 to the communication base part 48 of the master-system workflow monitor system 4.

If there is a problem detected when the communication base part 48 receives the replica creating transaction request result c96, a communication base part of another subordinate-system decentralized workflow monitor system is called successively to send the replica creating transaction request c94 including the information within the replica request c93.

The broadcast replica when starting the entire combined Wf definition anew is not only conducted from the master-system decentralized workflow monitor system 4 to the subordinate-system decentralized workflow monitor system 5, but also performed bidirectionally without exceptions when there is a change in an arbitrary decentralized workflow monitor system that can be the start point.

Subsequently, the statistical data processing will be described. The master-system decentralized workflow monitor system 4 includes the batching part 46 which performs statistical and evaluation processing based on the data stored and managed in the event storage DB 42.

The batching part 46 starts up at every designated time, and searches the records of the message instances stored in the event storage DB 42 as appropriate. Specifically, this corresponds to the service event management table 66 shown in FIG. 7. Particularly, the batching part 46 takes out a record group c62 of the message instances required for the designated statistical processing, and uses it as an input for calculation within the batching part 46.

At a point where the designated statistical processing calculation is completed, a result value c63 acquired thereby is stored in the event storage DB 42. Specifically, this corresponds to the statistical data management table 67 shown in FIG. 7. Through this, such statistical data can be used at the time of tracking.

The statistical data processing described above applies not only to the master-system decentralized workflow monitor system 4 but also to the subordinate-system decentralized workflow monitor system 5.

Subsequently, the outline of the procedure when grasping and searching the state of the workflow by using the integrated/combined Wf definition and the meta-information after distributing those definition and information will be described by referring to the case of the subordinate-system decentralized workflow monitor system 5 according to FIG. 6.

When the combined process definition name to be searched or a part thereof is inputted as a search character string into a designated input section through GUI (Graphical User Interface) on a client site 6, a Wf definition search request message c71 is transferred to the subordinate-system decentralized workflow monitor system 5 from the client site 6. Then, after the searching function part 37 receives the Wf definition search request message c71, a search inquiry c72 regarding the combined process definition is made on the combined Wf definition 35 to acquire a search result c73. Here, mainly the combined workflow definition description table 60 and the like shown in FIG. 7 are searched. Thereafter, the searching function part 37 returns a search result c74 to the client site 6, and a list of the combined process definition names is displayed.

Subsequently, when one is selected from the list of the combined process definition names and something that specifies the execution instance of the combined process (e.g., the execution data or the processing ID) is designated through GUI on the client site 6, a designated Wf definition tracking display request message c75 is transferred to the subordinate-system decentralized workflow monitor system 5 from the client site 6. The execution data, the processing ID, or the like is converted to corresponding “+ generated event date” or “+ accumulated process instance ID”.

Thereafter, when the searching function part 37 receives the designated Wf definition tracking display request message c75, a search request c76 is made for the combined Wf definition 35 in order to search a list of the related workflow definition information belonging to the designated combined process definition names. Here, the combined workflow definition description table 60, the workflow/process definition description table 61, and the service call activity definition table 62 are searched in order. As a result, the combined Wf definition 35 returns a list c77 of the workflow definition information belonging to the designated combined process definition names to the searching function part 37. This is the information item contained in the workflow/process definition description table 61 and the service call activity definition table 62 shown in FIG. 7, which corresponds to the workflow definitions 25, 28, 56, etc.

Subsequently, the searching function part 37 issues a search request c78 to the event storage DB 43 for acquiring a list of event group related to the corresponding message and the messages in the engine, by designating “+ generated event date”, “+ accumulated process instance ID”, or the like, corresponding to the execution date, the processing ID, or the like, having the workflow definition information of the designated combined process definition, and specified within the designated Wf definition tracking display request message c75. As a result, the service event management table 66 shown in FIG. 7 is searched to acquire the record of the corresponding message instance, and the record is returned to the searching function part 37 as a search result c79.

In a list c77 of the workflow definition information belonging to the designated combined process definition names acquired as a result of giving the search request c76 to the combined Wf definition 35 for searching the list of the related workflow definition information belonging to the designated combined process definition names, there exits information of a remote type that is not handled by the subordinate-system decentralized workflow monitor system 5. Specifically, the remote types are those having items 69 and 69′, which are related to “+ placed domain section (own domain, other domain)” in the workflow/process definition description table 61 and the service call activity definition table 62 shown in FIG. 7, designated as belonging to a different site. In that case, the search result c79 received from the event storage DB 43 does not contain all the information, unless it is being cached. Even if it is being cached, there also exists invalidated information because of the time limit as in an item 71″ regarding “+ cache data acquired date” and “+ cache validity section (valid, timeout)” shown in FIG. 7.

When the searching function part 37 acquires those (even though belonging to the designated combined process definition names) having items 69 and 69′ related to “+ placed domain section (own domain, another domain)” in the workflow/process definition description table 61 and the service call activity definition table 62 shown in FIG. 7 designated as belonging to a different site and invalidated information because of the time limit as in an item 71″ regarding “+ cache data acquired date” and “+ cache validity section (valid, timeout)” in the service event management table 66 shown in FIG. 7, the searching function part 37 issues a search request c80 to the communication base part 49 in order to acquire a latest list of the event group regarding the message in the engine and the event group regarding the corresponding message.

In the search request c80, “+ generated event date”, “+ accumulated process instance ID”, or the like, corresponding to the execution date, the processing ID, or the like, having the workflow definition information of the designated combined process definition, and specified within the designated Wf definition tracking display request message c75, are designated. The search request c80 contains all the information for acquiring the list of the event group regarding the messages in the engine and the event group regarding the corresponding messages managed by another decentralized workflow monitor system.

When the communication base part 49 receives the search request c80, the communication base part 49 sends the search request c80 as a search request c81 to the corresponding communication base part by setting a routing to the designated decentralized workflow monitor system. Here, this is referring the case of the master-system workflow monitor system 4 as a way of example, so that the communication base part 48 receives the search request c81.

When the communication base part 48 receives the search request c81, the communication base part 48 issues a search request c82 to the searching function part 36 within the master-system decentralized workflow monitor system 4 based on the search request c81.

When the searching function part 36 receives the search request c82, the searching function part 36 makes a verification request c85 for the combined Wf definition 34 by designating the related workflow definition information belonging to the designated combined process definition name that is one of the searching conditions contained in the search request c81.

Thereafter, the combined workflow definition description table 60, the workflow/process definition description table 61, and the service call activity definition table 62 shown in FIG. 7 are searched in order. However, the three tables in the combined Wf definition 34 are the original of the replicas, so that the contents thereof are different from the three corresponding tables of the combined Wf definition 35 as the caller.

When there is no specific mismatching or the like found in the combined Wf definition 34, it is so responded. When there is an error or the like, a verification request result c86 is returned to the searching function part 36 as a response indicating that there is an error.

Subsequently, a search request c83 is made for the event storage DB 42 by having the related workflow definition information belonging to the designated combined process definition name that is one of the searching conditions contained in the search request c81, the “+ generated event date”, “+ accumulated process instance ID”, or the like, corresponding to the execution date, the processing ID, or the like, contained in the search request c81, as arguments.

Within the event storage DB 42, the service event management table 66 shown in FIG. 7 is searched. Through designating “+ generated event date”, “+ accumulated process instance ID”, or the like, having the workflow definition information of the designated combined process definition and specified within the search request c83, a list of the event group regarding the message in the engine and the event group regarding the corresponding message is acquired. The acquired list is returned to the searching function part 36 as a search result c84.

Thereafter, the searching function part 36 edits the search result c84 into a response form including the case of having an error, and transmits it to the communication base part 49 as a search result c88. This search result c88 is returned to the searching function part 37 as a search result c89 for the search request c80.

The procedure in FIG. 6 is executed by the searching function part 37 every time it is tried to acquire the workflow definition information belonging to the designated combined process definition name but managed in the remote master-system decentralized workflow monitor system 4 or other subordinate-system workflow monitor systems, and the list of the event group regarding the messages in the engine and the event group regarding the corresponding messages.

Further, the procedure in FIG. 6 is executed not only in the subordinate-system decentralized workflow monitor system 5 but also in the master-system decentralized workflow monitor system 4 or all the other subordinate-system decentralized workflow monitor systems.

Upon receiving the search result c89 for the whole search request c80, the searching function part 37 creates a display request c90 together with the search result c79, and starts up the tracking display creating part 45. Upon receiving the display request c90, the tracking display creating part 45 searches, from the combined Wf definition 35, semantic information/expression information c91 on the application inputted by using the AP label entering part 53, and returns a drawing request c92 so as to display the search result and the grasped state of the workflow designated through GUI on the client site 6 that has a session with the searching function part 37.

As a result, the grasped state of the workflow and the search result are displayed through GUI on the client site 6.

Further, upon receiving the search result, in order to improve the search efficiency, the searching function parts such as the searching function part 36 and the searching function part 37 may store the search result as a cache in the event storage DB within the decentralized workflow monitor system that has conducted the search.

Specifically, when the searching function part 37 shown in FIG. 6 receives the search result c89, the searching function part 37 generates a record corresponding to the search result c89 and stores it to the process execution instance management table 65 and the service event management table 66 of FIG. 7 managed in the event storage DB 43. At that time, a proceeding c97 for changing a value of the cache update times is conducted for having cache consistency.

When conducting the proceeding c97, in order to achieve the consistency in the cache updates, a combination master key item 73′ is formed in the process execution instance management table 65 by adding “+ placed domain monitor system definition ID”, “+ cache update time ID” to the semantic combination master key item “+ placed workflow system definition ID”, “+ accumulated process instance ID” 73.

Further, a combination master key item 74′ is formed in the service event management table 66 by adding “+ placed domain monitor system definition ID”, “+ cache update time ID” to the semantic combination master key item “+ placed workflow system definition ID”, “+ accumulated process instance ID” 74.

Further, proper values are set to the items 71 and 71′ regarding “+ cache data acquired date”, “+ cache validity section (valid, timeout)”. Through this, the consistency in the cache updates can be secured.

### Second Exemplary Embodiment

FIG. 1 of the present invention shows mainly the functions of the work process monitoring/tracking apparatus, but does not specifically refer to the structural elements. A case where the elements functionally equivalent to those of FIG. 1 can be achieved as appropriate can also be included as a target of the present invention.

As another exemplary embodiment, assumed is a case where the work process monitoring/tracking apparatus and the like of the present invention are held by a service provider operating organization, and defined as services. This is defined as same as the second exemplary embodiment disclosed in a preceding Application or the like. That is, the parts excluding the work application systems 7, 8, 9, 10 and the client sites 6, 54 in FIG. 1 may be held at the service provider operating organization and defined as the services.

In this exemplary embodiment of the invention, it is preferable for a subordinate workflow integrated management apparatus to have a device which refers to a replica received from a master workflow integrated management apparatus, and acquires event information of a tracking target from another workflow integrated management apparatus. Further, it is preferable for the subordinate workflow integrated management apparatus to have a device which stores the event information acquired from another workflow integrated management apparatus as a cache.

In this exemplary embodiment of the invention, it is preferable for each of the workflow integrated management apparatus to have a device which transmits the information indicating the execution state of the workflow to all the other workflow integrated management apparatuses, when the own apparatus starts the integrated workflow.

In this exemplary embodiment of the invention, it is preferable to have a step in which a subordinate workflow integrated management apparatus refers to a replica received from a master workflow integrated management apparatus, and acquire event information of a tracking target from another workflow integrated management apparatus. Further, it is preferable to have a step in which the subordinate workflow integrated management apparatus stores the event information acquired from another workflow integrated management apparatus.

In this exemplary embodiment of the invention, it is preferable to have a step in which each of the workflow integrated management apparatus transmits the information indicating the execution state of the workflow to all the other workflow integrated management apparatuses, when the own apparatus starts the integrated workflow.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on JP 2006-301808 filed on Nov. 7, 2006, and the disclosure thereof is hereby incorporated by reference in its entirety.

### BRIEF DESCRIPTION OF THE DRAWINGS

FIG. 1 is an illustration showing an outline of an overall structure of the optimum form of the present invention which is a work process monitoring/tracking apparatus based on a decentralized workflow management/collection method used for a large-scaled operation;

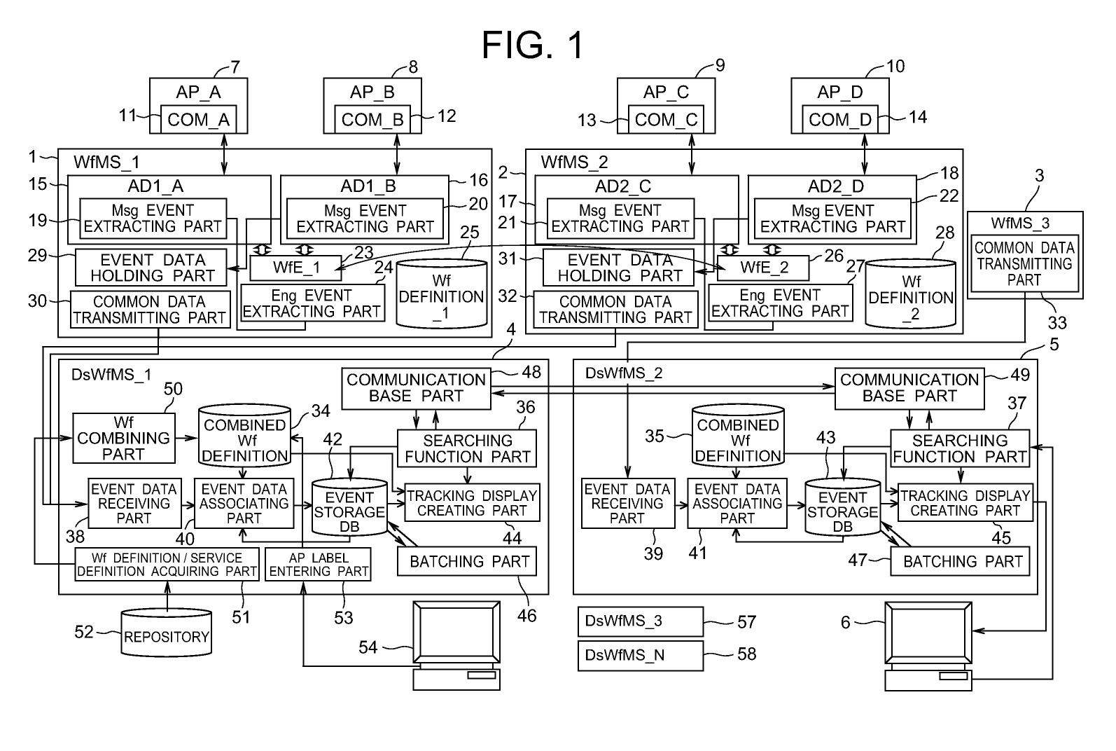

FIG. 2 is an illustration showing an outline of a procedure of the present invention, when collecting event information from dispersedly arranged workflow engines;

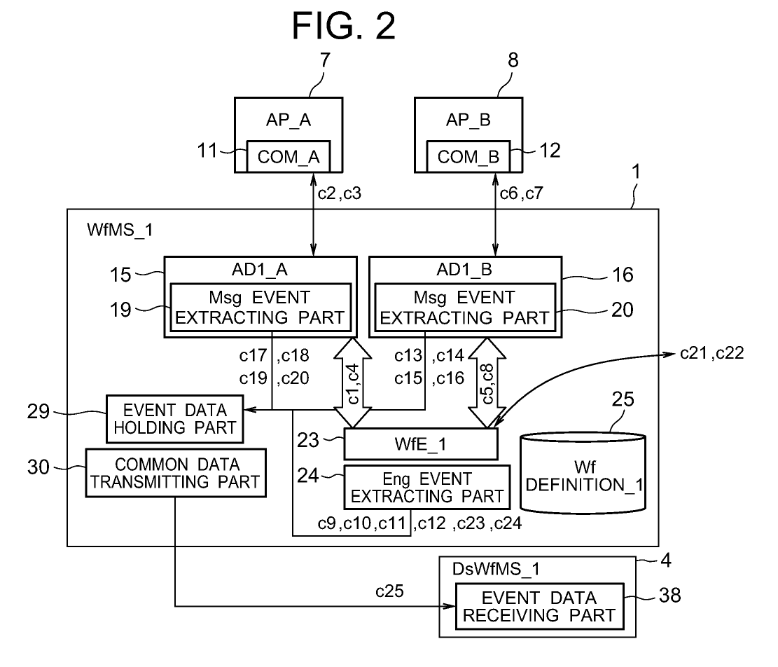

FIG. 3 is an illustration showing an outline of a procedure of the present invention, when collecting a group of workflow definitions (referred to as Wf definitions hereinafter) held individually at the dispersedly arranged workflow engines, and creating integrated/combined Wf definition;

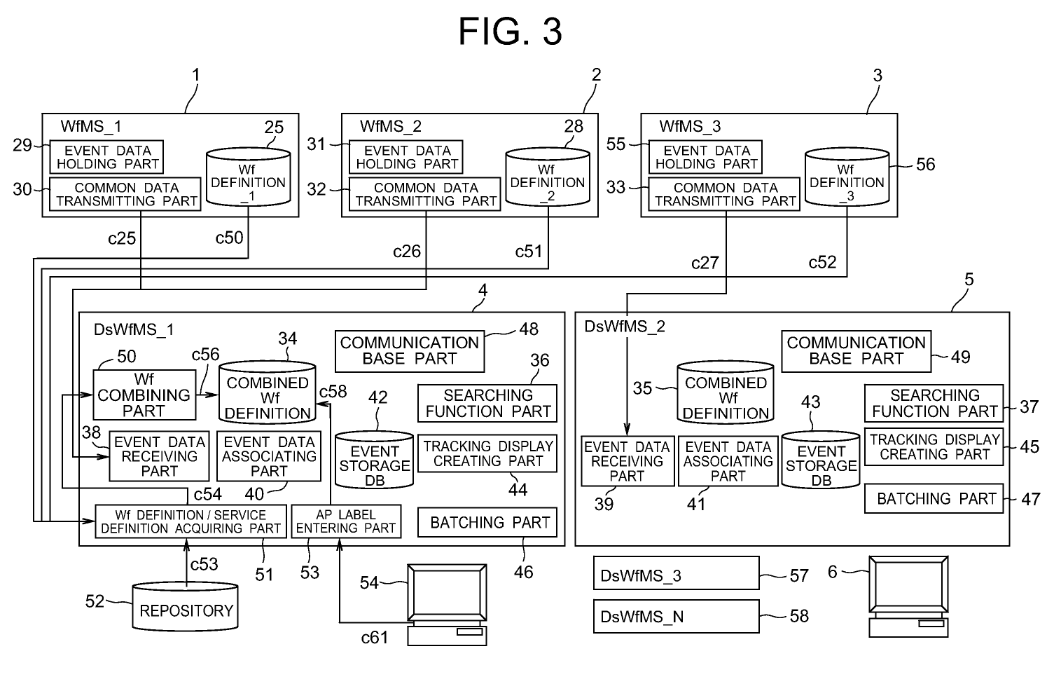

FIG. 4 is an illustration showing an outline of a procedure of the present invention, when distributing replicas of the integrated/combined Wf definition and meta-information to each decentralized workflow monitor system;

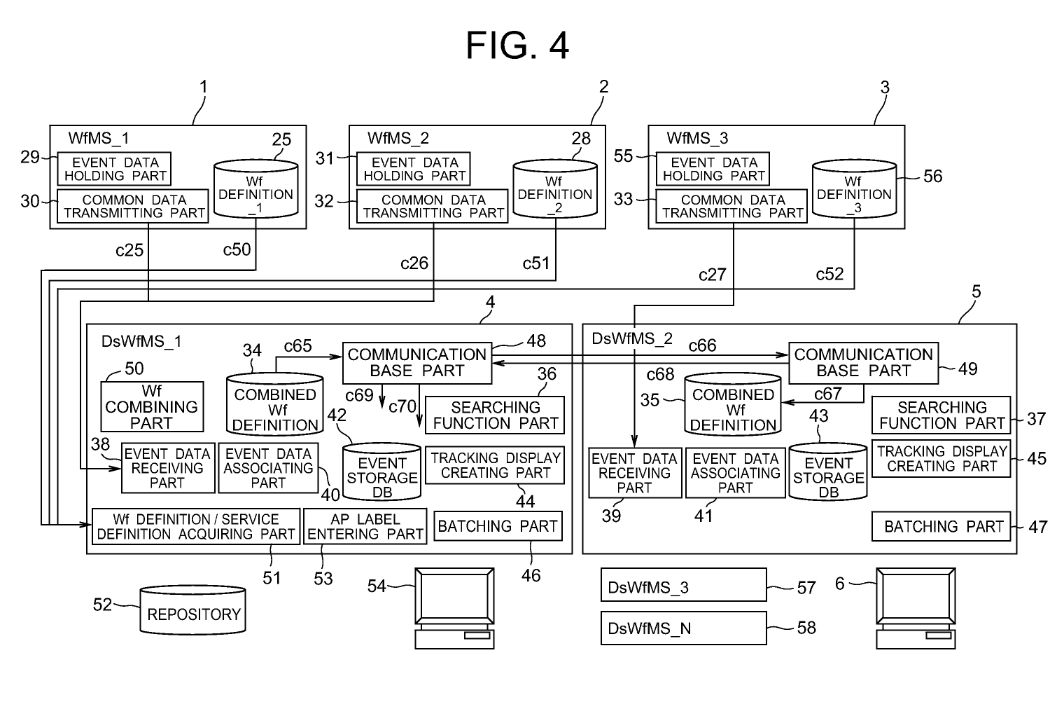

FIG. 5 is an illustration showing an outline of a procedure of the present invention, when updating an execution state of the workflow by using the integrated/combined Wf definition and meta-information after distributing those definition and information;

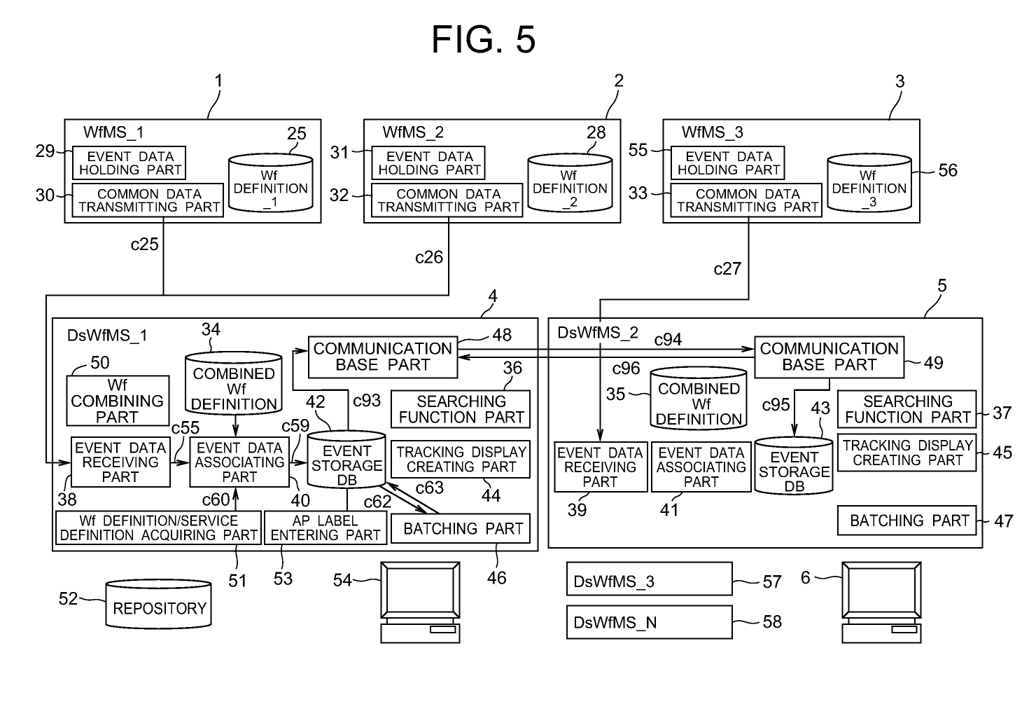

FIG. 6 is an illustration showing an outline of a procedure of the present invention, when searching and grasping the execution state of the workflow by using the integrated/combined Wf definition and meta-information after distributing those definition and information;

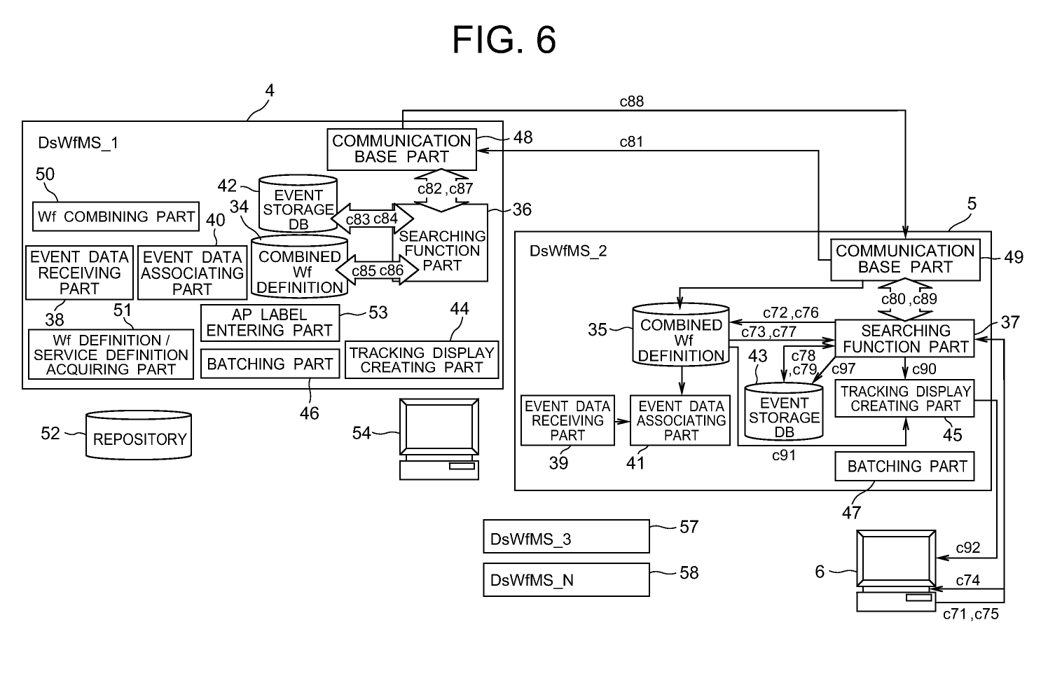

FIG. 7 shows a data structure including the integrated/combined Wf definition and meta-information among the present invention;

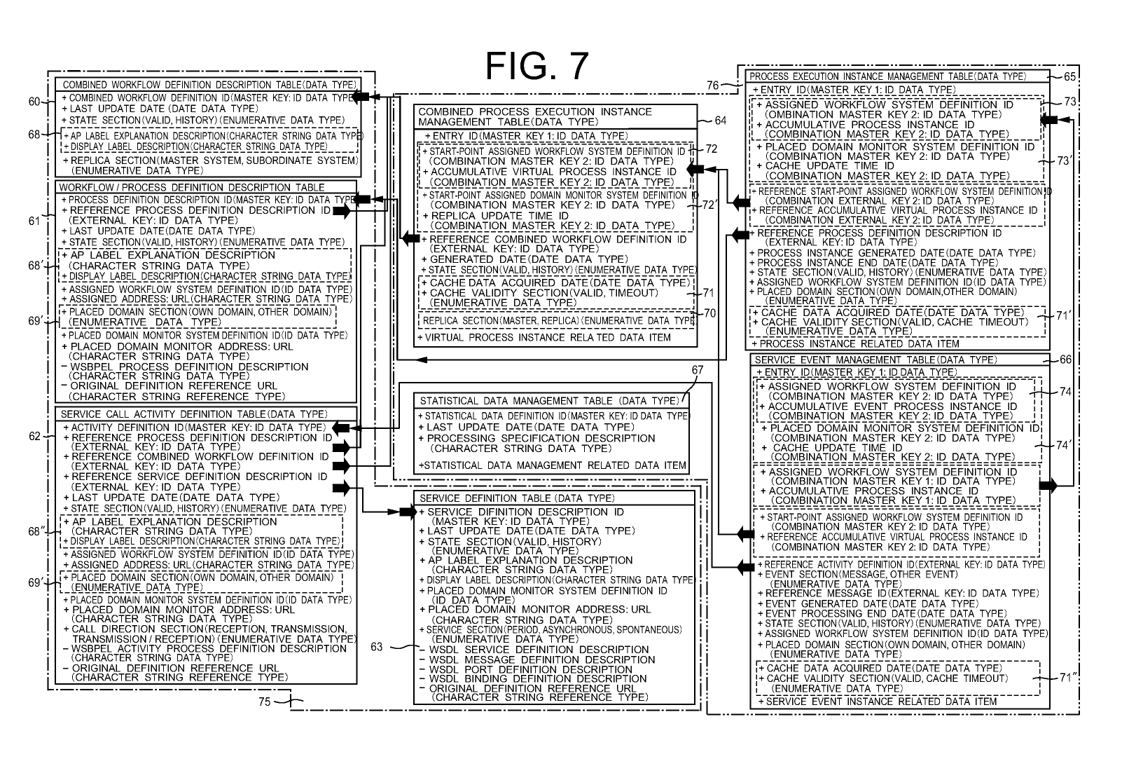

FIG. 8 shows the structure and relations regarding domains, decentralized workflow monitor systems, and workflow systems of the present invention;

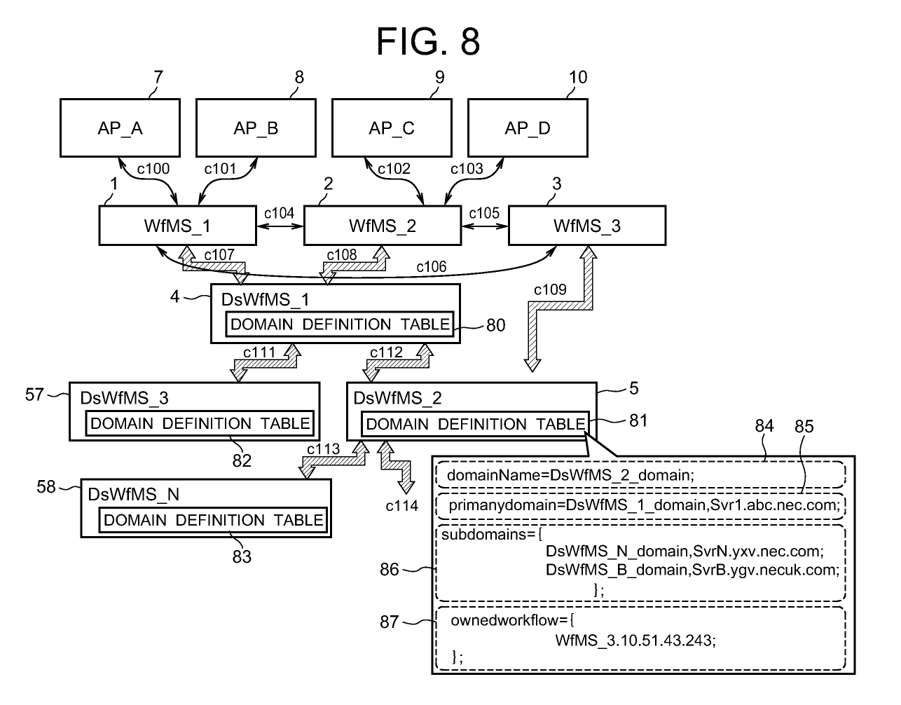

FIG. 9 is an illustration showing an example of a system structure of a method which uses a technique related to work process tracking according to a decentralized workflow management method of a decentralized management concept depicted in a preceding Application; and

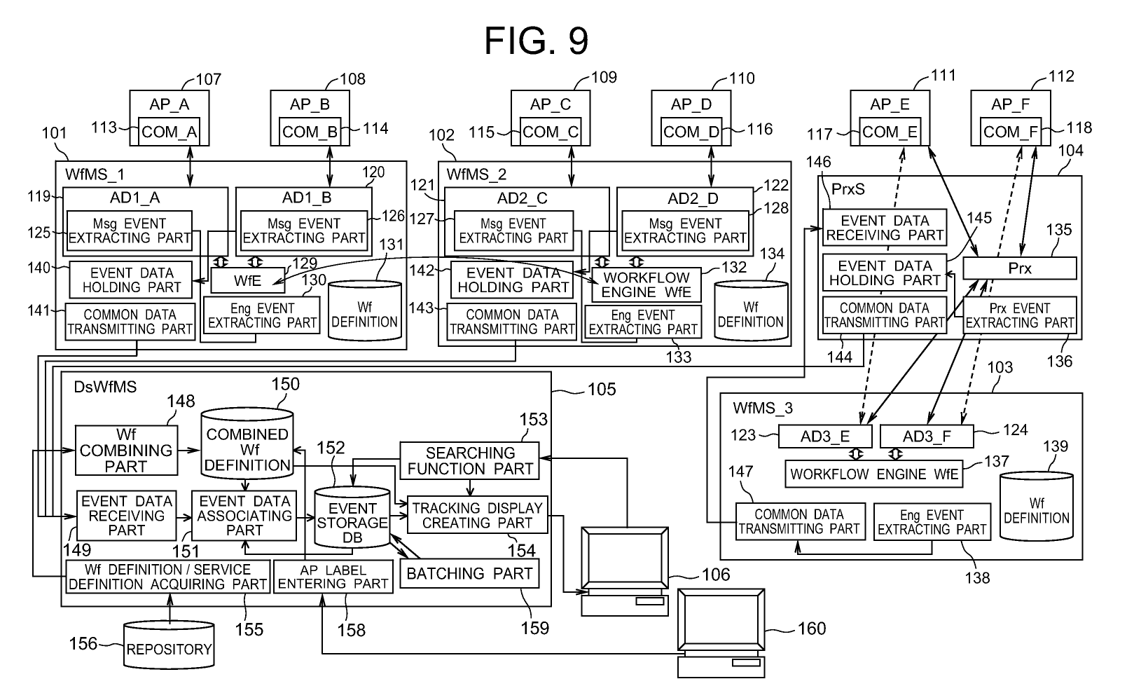

FIG. 10 is an illustration showing an example of a system structure of a method which uses a technique related to process tracking of a decentralized management concept depicted in Patent Document 1.

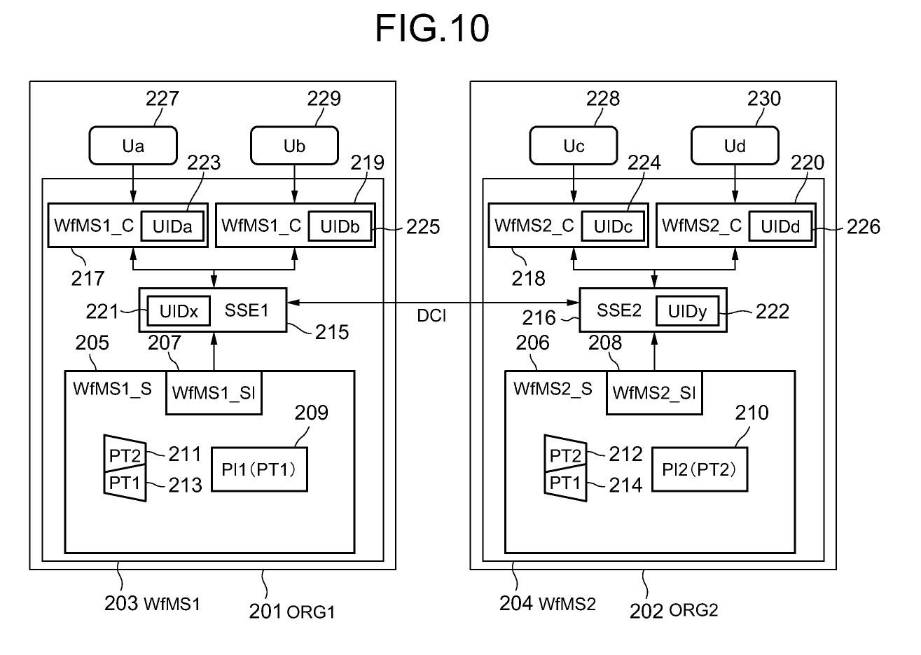

### REFERENCE NUMERALS

1, 2, 3 Workflow system

4 Master-system workflow monitor system

5, 57, 58 Subordinate-system decentralized workflow monitor system

6 Client site by Web browser

7, 8, 9, 10 Work application system

11, 12, 13, 14, 15, 16, 17 Data communication part

15, 16, 17, 18 Adapter

19, 20, 21, 22 Msg event extracting part

23, 26 Workflow engine

24, 27 Eng event extracting part

25, 28, 56 Workflow definition

29, 31 Event data holding part

30, 32, 33 Common data transmitting part

34, 35 Combined Wf definition

36, 37 Searching function part

38, 39 Event data receiving part

40, 41 Event data associating part

42, 43 Event storage DB

44, 45 Tracking display creating part

46, 47 Batching part

48, 49 Communication base part

50 Wf combining part

51 Wf definition/service definition acquiring part

52 Repository

53 AP label entering part

5, 54 Client site by Web browser

80, 81, 82, 83 Domain definition table

84 Domain name definition

85 Definition of master domain

86 List of subordinate domain definitions

87 List of definitions of workflow system group belonging to domain

c1, c2, c5, c6, c21 Processing request message

c3, c4, c7, c8, c22 Processing response message

c9, c10, c11, c12, c23, c24 Event related to message in engine

c13, c14, c15, c16, c17, c18, c19, c20 Event related to message

c25, c26 Event data transfer message

c50, c51, c52 Definition transfer message

c53 Inquiry

c54 Workflow definition information

c55 Entire data related to event

c56 Integrated/combined workflow definition combined result

c57 Service definition/process definition information

c58 Operation request

c59 Message instance record

c61, c91 Semantic information/expression information

c62 Message instance record group

c63 Result value

c65 Original information

c66, c70 Transaction request

c67 Update processing proceeding

c68 Transaction request result

c69 Alarm

c71 Wf definition search request message

c72 Search inquiry

c73, c74, 79, c84, c88, c89 Search result

c75 Designated Wf definition tracking display request message

c76, c78, 81, 82, c85, c89 Search request

c77 List of workflow definition information

c86 Verification request result

c92 Drawing result

c93 Replica request

c94 Replica creating transaction request

c95 Creation processing proceeding

c96 Replica creating transaction request result

c97 Proceeding for changing cache update time

c100, c101, c102, c103, c104, c105, c106 Communicating relation

c107, c108, c109 Specific relation

c111, c112, c113, c114 Relation

60 Combined workflow definition description table

61 Workflow/process definition description table

62 Service call activity definition table

63 Service definition table

64 Combined process execution instance management table

65 Process execution instance management table

66 Service event management table

67 Statistical data management table

68 Item related to + AP label explanation description, + display label description

68′ Item related to + AP label explanation description, + display label description

68″ Item related to + AP label explanation description, + display label description

69 Item related to + placed domain section (own domain, other domain)

69′ Item related to + placed domain section (own domain,

other domain) 70 Item related to + replica section (master, replica)

71 Item related to + cache data acquired date, + cache validity section (valid, timeout)

71′ Item related to + cache data acquired date, + cache validity section (valid, timeout)

71″ Item related to + cache data acquired date, + cache validity section (valid, timeout)

72 Semantical combination master key item in combined process execution instance management table

72′ Combination master key item in combined process execution instance management table

73 Semantical combination master key item in process execution instance management table

73′ Combination master key item in process execution instance management table

74 Semantical combination master key item in service event management table

74′ Combination master key item in service event management table

75 Combined Wf definition corresponding part

76 Event storage DB corresponding part

101, 102 Workflow system according to decentralized workflow management method

103 Self-loaded/existing workflow system

104 Proxy system

105 Decentralized workflow monitor system

106, 160 Client site by Web browser

107, 108, 109, 110, 111, 112 Work application system

113, 114, 115, 116, 117, 118 Data communication part

119, 120, 121, 122, 123, 124 Adapter

125, 126, 127, 128 Msg event extracting part

129, 132, 137 Workflow engine

130, 133, 138 Eng event extracting part

131, 132, 139 Workflow definition

135 Proxy part

136 Prx event extracting part

140, 142, 145 Event data holding part

141, 143, 144, 147 Common data transmitting part

146 Common data receiving data

148 Workflow combining part

149 Event data receiving part

150 Combined Wf definition

151 Event data associating part

152 Event storage DB

153 Searching function part

154 Tracking display creating part

155 Wf definition/service definition acquiring part

156 Repository

157 Other workflow definition

158 AP label entering part

159 Batching part

201, 202 Organization

203, 204 Workflow management system

205, 206 Workflow management system server

207, 208 Existing interface

209 Process instance

211, 213 Process template

215, 216 State shadowing engine

217, 218 Workflow management system client

227, 228, 229, 230 User

What is claimed is:

1. A workflow tracking system, comprising a plurality of workflow execution apparatuses for managing/executing a workflow and a plurality of workflow integration management apparatuses for tracking the workflow, wherein:
each of the workflow execution apparatuses comprises
a device which shows contents of events generated in the apparatus itself when executing an arbitrary workflow managed by the apparatus itself, and records peculiar event information by each of the events,
a device which transmits a workflow description which shows contents of the workflow in a standardized data form to a single master workflow integration management apparatus that is determined in advance among the workflow integration management apparatuses, and
a device which transmits the recorded event information to a subordinate workflow integration management apparatus that is determined in advance for each of the workflow execution apparatuses;
the workflow integration management apparatus comprises
an event association detecting device which detects association of each event specified by the event information acquired from each of the workflow execution apparatuses with respect to other events, and
an event information recording device which records all of the event information acquired from each of the workflow execution apparatuses;
the master workflow integration management apparatus comprises, in addition to the event association detecting device and the event information recording device,
a device which integrates a plurality of the workflows to generate an integrated workflow based on the workflow descriptions and the event information acquired from each of the workflow execution apparatuses and based on a detection result of the event association detecting device, and
a device which transmits a replica of the integrated workflow to the subordinate workflow integration management apparatuses other than the master workflow integration management apparatus; and
the subordinate workflow integration management apparatus comprises, in addition to the event association detecting device and the event information recording device,
a device which receives the replica of the integration workflow from the master workflow integration management apparatus.

2. The workflow tracking system as claimed in claim 1, which is formed in a hierarchical structure configured with a single master domain formed with the single master workflow integration management apparatus and at least a single workflow execution apparatus, and at least a single subordinate domain belonging to the master domain, which is formed with the single subordinate workflow integration management apparatus and at least a single workflow execution apparatus.

3. The workflow tracking system as claimed in claim 1, wherein the subordinate workflow integration management apparatus has a device which refers to the replica received from the master workflow integration management apparatus, and acquires event information of a tracking target from the other workflow integration management integration management apparatuses.

4. The workflow tracking system as claimed in claim 3, wherein the subordinate workflow integration management apparatus has a device which stores the event information acquired from the other workflow integration management apparatuses as a cache.

5. The workflow tracking system as claimed in claim 1, wherein the each of the workflow integration management apparatuses has a device which transmits information showing an execution state of the integration workflow to all the other workflow integration management apparatuses, when the apparatus itself starts the integration workflow.

6. A workflow integration management apparatus for tracking a workflow, which comprises:
an event association detecting device which, with respect to other events, detects association of each event specified by event information acquired from a plurality of workflow execution apparatuses for managing/executing a workflow;
an event information recording device which records all of the event information acquired from each of the workflow execution apparatuses;
a device which integrates a plurality of the workflows to generate an integrated workflow based on the workflow descriptions and the event information acquired from each of the workflow execution apparatuses and based on a detection result of the event association detecting device; and
a device which transmits a replica of the integration workflow to the other workflow integration management apparatuses which do not have a device for generating the integrated workflow.

7. A workflow integration management apparatus for tracking a workflow, which comprises:
an event association detecting device which, with respect to other events, detects association of each event specified by event information acquired from a plurality of workflow execution apparatuses belonging to a same domain as that of the apparatus itself for managing/executing a workflow;
an event information recording device which records all of the event information acquired from each of the workflow execution apparatuses belonging to the same domain as that of the apparatus itself;
a device which integrates a plurality of the workflows to generate an integrated workflow based on the workflow descriptions and the event information acquired from each of the workflow execution apparatuses belonging to the same domain as that of the apparatus itself and based on a detection result of the event association detecting device; and
a device which transmits a replica of the integration workflow to the other workflow integration management apparatuses belonging to a different domain from that of the apparatus itself, which do not have a device for generating the integrated workflow.

8. A workflow integration management method achieved by using a plurality of workflow execution apparatuses for managing/executing a workflow and a plurality of workflow integration management apparatuses for tracking the workflow, the method comprising:
a step which, by each of the workflow execution apparatuses, shows contents of events generated in the apparatus itself when executing an arbitrary workflow managed by the apparatus itself, and records peculiar event information by each of the events;
a step which, by each of the workflow execution apparatuses, transmits a workflow description which shows contents of the workflow in a standardized data form to a single master workflow integration management apparatus that is determined in advance among the workflow integration management apparatuses;
a step which, by each of the workflow execution apparatuses, transmits the recorded event information to a subordinate workflow integration management apparatus that is determined in advance for each of the workflow execution apparatuses;
an event association detecting step which, by the workflow integration management apparatus, detects association of each event specified by the event information acquired from each of the workflow execution apparatuses with respect to other events;
an event information recording step which, by the workflow integration management apparatus, records all of the event information acquired from each of the workflow execution apparatuses;
a step which, by the master workflow integration management apparatus, integrates a plurality of the workflows to generate an integrated workflow based on the workflow descriptions and the event information acquired from each of the workflow execution apparatuses and a detection result of the event association detecting device;
a step which, by the master workflow integration management apparatus, transmits a replica of the integrated workflow to the subordinate workflow integration management apparatuses other than the master workflow integration management apparatus; and
a step which, by the subordinate workflow integration management apparatus, receives the replica of the integration workflow from the master workflow integration management apparatus.

9. The workflow integration management method as claimed in claim 8, which employs a hierarchical structure configured with a single master domain formed with the single master workflow integration management apparatus and at least a single workflow execution apparatus, and at least a single subordinate domain belonging to the master domain, which is formed with the single subordinate workflow integration management apparatus and at least a single subordinate workflow execution apparatus.

10. The workflow integration management method as claimed in claim 8, comprising a step in which the subordinate workflow integration management apparatus refers to the replica received from the master workflow integration management apparatus, and acquires event information of a tracking target from other workflow integration management integration management apparatuses.

11. The workflow integration management method as claimed in claim 10, comprising a step in which the subordinate workflow integration management apparatus stores the event information acquired from the other workflow integration management apparatuses as a cache.

12. The workflow integration management method as claimed in claim 8, comprising a step in which each of the subordinate workflow integration management apparatus transmits information showing an execution state of the integration workflow to all the other workflow integration management apparatuses, when the apparatus itself starts the integration workflow.

13. (canceled)

14. A computer readable information recording medium carrying a workflow tracking system program for tracking managed/executed workflows to perform integration and management thereof, which enables a computer to execute:
a function which shows contents of events generated in the apparatus itself when executing an arbitrary workflow managed by the apparatus itself, and records peculiar event information by each of the events;
a function which detects association of each event specified by the acquired event information with respect to other events;
a function which records all of the acquired event information; and
a function which integrates a plurality of the workflows to generate an integrated workflow based on the acquired workflow descriptions and the event information and detected information of the association of the event with respect to the other events.

15. (canceled)

16. A computer readable information recording medium carrying a workflow integration management program for tracking a workflow, which enables a computer to execute:
a function which, with respect to other events, detects association of each event specified by event information acquired by managing/executing the workflow;
a function which records all of the acquired event information; and
a function which integrates a plurality of the workflows to generate an integrated workflow based on the acquired workflow descriptions and the event information and detected information of the association of the event with respect to the other events.

17. (canceled)

18. A computer readable information recording medium carrying a workflow integration management program for tracking a workflow, which enables a computer to execute:
a function which, with respect to other events, detects association of each event specified by the event information acquired by managing/executing the workflow which belongs to a same domain as that of an apparatus itself;
a function which records all of the event information acquired from each workflow execution apparatus belonging to the same domain as that of the apparatus itself; and
a function which integrates a plurality of the workflows to generate an integrated workflow based on the workflow descriptions and the event information acquired from each of the workflow execution apparatuses belonging to the same domain as that of the apparatus itself and detected information of the association of the event with respect to the other events.

19. A workflow tracking system, comprising a plurality of workflow execution means for managing/executing a workflow and a plurality of workflow integration management means for tracking the workflow, wherein:
each of the workflow execution means comprises
means for showing contents of events generated in the workflow execution means itself when executing an arbitrary workflow managed by the workflow execution means itself, and records peculiar event information by each of the events,
means for transmitting a workflow description which shows contents of the workflow in a standardized data form to a single master workflow integration management apparatus that is determined in advance among the workflow integration management means, and
means for transmitting the recorded event information to a subordinate workflow integration management apparatus that is determined in advance for each of the workflow execution means;
the workflow integration management means comprises
event association detecting means for detecting association of each event specified by the event information acquired from each of the workflow execution means with respect to other events, and
event information recording means for recording all of the event information acquired from each of the workflow execution means;
the master workflow integration management apparatus comprises, in addition to the event association detecting means and the event information recording means,
means for integrating a plurality of the workflows to generate an integrated workflow based on the workflow descriptions and the event information acquired from each of the workflow execution means and based on a detection result of the event association detecting means, and
means for transmitting a replica of the integrated workflow to the subordinate workflow integration management apparatuses other than the master workflow integration management apparatus; and
the subordinate workflow integration management apparatus comprises, in addition to the event association detecting means and the event information recording means,
means for receiving the replica of the integration workflow from the master workflow integration management apparatus.

20. Workflow integration management means for tracking a workflow, which comprises:
event association detecting means for, with respect to other events, detecting association of each event specified by event information acquired from a plurality of workflow execution means for managing/executing a workflow;
event information recording means for recording all of the event information acquired from each of the workflow execution means;
means for integrating a plurality of the workflows to generate an integrated workflow based on the workflow descriptions and the event information acquired from each of the workflow execution means and based on a detection result of the event association detecting means; and
means for transmitting a replica of the integration workflow to the other workflow integration management means which do not have means for generating the integrated workflow.

21. Workflow integration management means for tracking a workflow, which comprises:
event association detecting means for, with respect to other events, detecting association of each event specified by event information acquired from a plurality of workflow execution means belonging to a same domain as that of the workflow integration management means itself for managing/executing a workflow;
event information recording means for recording all of the event information acquired from each of the workflow execution means belonging to the same domain as that of the workflow integration management means itself;
means for integrating a plurality of the workflows to generate an integrated workflow based on the workflow descriptions and the event information acquired from each of the workflow execution means belonging to the same domain as that of the workflow integration management means itself and based on a detection result of the event association detecting means; and
means for transmitting a replica of the integration workflow to the other workflow integration management means belonging to a different domain from that of the workflow integration management means itself, which do not have means for generating the integrated workflow.
